(19) United States
(12) Patent Application Publication
(10) Pub. No.: US 2026/0337057 A1
(43) Pub. Date: Oct. 29, 2026

(54) Removal of Per- and Polyfluoroalkyl Substances (PFAS) from Water by Foam Fractionation

(71) Applicant: Brown University, Providence, RI (US)

(72) Inventors: Kurt Pennell, Pittsburgh, PA (US); Craig Klevan, Langhorne, PA (US)

(21) Appl. No.: 19/468,204

(22) Filed: Feb. 3, 2026

Related U.S. Application Data
(60) Provisional application No. 63/753,715, filed on Feb. 4, 2025.
(60) Provisional application No. 63/777,267, filed on Mar. 25, 2025.
(60) Provisional application No. 63/797,028, filed on Apr. 29, 2025.
(60) Provisional application No. 63/903,485, filed on Oct. 22, 2025.

(51) Int. Cl. C02F 1/24; C02F 101/36

(52) U.S. Cl. CPC C02F 1/24; C02F 2101/36; C02F 2201/002; C02F 2209/02; C02F 2209/44; C02F 2301/08; C02F 2303/185

(57) ABSTRACT

The instant invention relates to methods and systems to purify water contaminated with PFAS using surfactants.

### RELATED APPLICATION DATA

This application claims the benefit of U.S. Provisional Application 63/753,715 filed Feb. 4, 2025, U.S. Provisional Application 63/777,267 filed Mar. 25, 2025, U.S. Provisional Application 63/797,028 filed Apr. 29, 2025 and U.S. Provisional Application 63/903,485 filed Oct. 23, 2025, each of which is hereby incorporated by reference in its entirety.

### STATEMENT REGARDING FEDERALLY SPONSORED RESEARCH OR DEVELOPMENT

This invention was made with government support under Grant Number W912HQ-23-C-0031 awarded by the United States Army Corps of Engineers (USACE). The government has certain rights in the invention.

### FIELD OF INVENTION

The present invention relates to a method of treating water contaminated with per- and polyfluoroalkyl substances (PFAS) using foam fractionation and surfactants that are environmentally friendly.

### BACKGROUND

Per- and polyfluoroalkyl substances (PFAS) are a class of anthropogenic, organofluoride chemicals consisting of over 10,000 different species used commercially since the 1940s. These chemicals have been manufactured for a myriad of different uses such as food packaging, waterproofing clothing, and fire suppression in aqueous film forming foams (AFFF). Due to their numerous strong C—F bonds, PFAS are resistant to many chemical and biological degradation processes making their presence in drinking water, groundwater, freshwater, oceans, soil, and vegetation thereby being harmful to animals and humans. Numerous studies have shown that two of the most common PFAS, perfluorooctanoic acid (PFOA) and perfluorooctanesulfonic acid (PFOS), are associated with adverse health outcomes including kidney disease, altered thyroid function, insulin dysregulation, and reproductive health.

PFAS can be divided into subclassifications based on characteristics such as charge and chain length. For example, the most thoroughly studied PFAS compounds are perfluoroalkyl acids (PFAAs), and more specifically, perfluoroalkyl carboxylic acids (PFCAs) and perfluoroalkyl sulfonic acids (PFSAs) which have a carboxylic acid or sulfonic acid head group, respectively, and carry a negative charge upon deprotonation. These charged headgroups are polar and hydrophilic, while the carbon fluorine chains are hydrophobic, rendering many PFAS of interest to be amphiphilic. This unique chemical structure results in accumulation or adsorption of PFAS at interfaces such as the air-water interface, where the nonpolar region of the molecule aligns with the air and the polar region is oriented toward the water. While many PFAS accumulate at the air-water interface, the extent of this process is directly proportional to the fluorocarbon chain length, with long-chain PFAS (e.g., >7 fluorinated carbons for PFCAs) adsorbing at much greater quantities than shorter-chain length PFAS. As a consequence, short-chain PFAS (e.g., 7 or fewer fluorinated carbons for PFCAs) tend to be more mobile in environmental media than long chain PFAS.

Among the various methods used to remove PFAS from water, foam fractionation has emerged as a leading method to remove per and polyfluoroalkyl substances (PFAS) from impacted aqueous matrices due to their low cost and rapid PFAS removal. Although foam fractionation has been shown to efficiently remove long-chain PFAS, cationic co-foaming agents are often necessary to improve the removal of short-chain PFAS. However, many of the best performing co-surfactants used for short-chain PFAS removal, such as cetyltrimethylammonium bromide (CTAB), are of concern due to their potential toxicity and low biodegradability.

PFAS have a tendency to adsorb to the air-water interface. This tendency of PFAS is exploited to remediate contaminated water using foam fractionation. Foam fractionation is a process in which air bubbles are injected into a column of contaminated water and as these bubbles rise through the water the PFAS preferentially adsorb to the air-water interface. A PFAS-concentrated foam accumulates at the top of the water column, which may be removed and treated, while the water column contains significantly lower PFAS concentrations. This process has been shown to effectively remove long-chain PFAS in both bench-scale and field-scale studies. It should be noted, however, that the aqueous matrix plays a large role as the ionic strength, pH, and salt composition may impact the removal efficiency, and if the water does not foam, PFAS are removed primarily by aerosolization and transported in the air. While foam fractionation is very effective at removing long-chain PFAS, short-chain PFAS frequently exhibit low removals which has led to the exploration of additives, such as metallic activators or co-foaming agents, to assist in their removal. Co-foaming agents—especially cationic surfactants—have proven to be particularly effective for improving the removal of short-chain PFAS as they serve a dual purpose of maintaining a stable foam in the system as well as facilitating the short-chain PFAS accumulation at the air-water interface. Cetyltrimethylammonium bromide (CTAB), as well as the identical compound with a different halogenic anion cetyltrimethylammonium chloride (CTAC), have proven to be the most effective co-surfactants for removing both long-chain and short-chain PFAS compounds. Foam fractionation removals of over 99% have been reported for both long and short-chain PFAS using CTAB or CTAC.

Despite the benefits of using CTAB or CTAC as a co-surfactant to enhance PFAS removal during foam fractionation, concerns have been raised regarding both their toxicity and poor biodegradability. These concerns have also been raised in other disciplines such as nanomaterials, where CTAB is used in the production of nano-porous silica for drug delivery. Several biological assays have been conducted to evaluate CTAB toxicity, with results showing decreased growth and death of both prokaryotic and eukaryotic cells. Rats given drinking water contaminated with CTAB were observed to have reduced efficiency in food conversion and in turn reduced body weights. These findings are not unexpected since CTAB is widely used as a biocide and disinfectant product. Due to the toxicity of CTAB and analogous compounds, there is need to identify foam fractionation additives that are biodegradable and exhibit lower toxicities than CTAB.

Several aeration and foam fractionation studies utilizing less toxic, more biodegradable cationic co-surfactants synthesized from natural products have been conducted with varying degrees of success. For example, PFAS removal was significantly increased in an aeration chamber with the addition of duckweed, yet this observation was only made for PFAS with a chain length of 7 and greater, and with initial PFAS concentrations that were orders of magnitude above regulatory limits. Likewise, whey soy protein has been shown to improve the removal of PFAS during foam fractionation, but again, only for long-chain PFAS. Hydroxypropyl methylcellulose (HPMC), a non-toxic cosmetic ingredient often used as a thickener, was also found to enhance removal of long chain PFAS as well as 6:2 FTS (6:2 Fluorotelomer sulfonate; C₈H₅F₁₃O₃S), yet had minimal effects on the removal of short-chain PFAS. Montaline C40™, a cationic coconut-derived surfactant used in cosmetics, was able to significantly increase removal of short-chain PFAS compounds, with PFPeA and PFBS removals of greater than over 80%, but PFBA removal actually decreased with the addition of this compound.

While several surfactants and methods have been available to remove PFAS contaminants from water, there still is a need for a surfactant for effectively removing both long chain and short chain surfactants that are not toxic in nature.

### SUMMARY OF THE INVENTION

The present invention provides a method of decontaminating PFAS contaminated water containing one or more PFAS contaminants, the method comprising decontaminating the PFAS contaminated water using a non-toxic surfactant.

Also provided by the present invention is a method for purifying PFAS contaminated water, the method comprising contacting the PFAS contaminated water with a surfactant at a pH ranging from about 3 to about 7, wherein the surfactant removes PFAS from the PFAS contaminated water, thereby purifying the PFAS contaminated water.

The present invention also provides a method for purifying PFAS contaminated water, the method comprising: purifying the PFAS contaminated water using a foaming agent to remove PFAS from the PFAS contaminated water, thereby purifying the PFAS contaminated water.

Another aspect provides a system for purifying PFAS contaminated water, the system comprising a foaming agent for purifying the PFAS contaminated water at a pH of from about 3 to about 7 to remove PFAS from the PFAS contaminated water, thereby purifying the PFAS contaminated water.

Also provided is a method for purifying PFAS contaminated water, the method comprising purifying the PFAS contaminated water using a foaming agent to remove PFAS from the PFAS contaminated water, thereby purifying the PFAS contaminated water.

The present invention provides a method for decontaminating water containing one or more PFAS contaminants, using foam fractionation to remove a PFAS contaminant from a water source, the method comprising:
(a) injecting a foaming agent, a surfactant, or a mixture thereof into an active column;
(b) providing a feed stream to an inlet of the active column, wherein the feed stream comprises the PFAS contaminated water;
(c) introducing the feed stream into an interior of the active column;
(d) injecting a gas through a diffuser and into the water so as to form a plurality of bubbles in the PFAS contaminated water;
(e) the plurality of gas bubbles in the feed stream, forming a foam layer, wherein (i) the foam layer is situated atop the feed stream in the interior of the active column, (ii) the foam layer comprises majority of the PFAS contaminant, and (iii) after the foam layer is formed, the interior of the active column comprises the foam layer and a purified stream
(f) collecting the foam layer by subjecting the active column under reduced pressure and disposing the foam layer;
(g) passing the purified stream into a next column, wherein the next column operates as the active column and the purified stream operates as the feed stream;
(f) continuously repeating steps (b) through (g) until the feed stream becomes a cleaned stream, wherein a cleaned stream comprises water with a concentration of PFAS contaminants are below a final desired concentration of the PFAS contaminant.

Further features and advantages of certain embodiments of the present invention will become more fully apparent in the following description of embodiments and drawings thereof, and from the claims.

### BRIEF DESCRIPTION OF THE DRAWINGS

The patent or application file contains drawings executed in color. Copies of this patent or patent application publication with the color drawings will be provided by the Office upon request and payment of the necessary fee. The foregoing and other features and advantages of the present embodiments will be more fully understood from the following detailed description of illustrative embodiments taken in conjunction with the accompanying drawings in which:

FIG. 1A depicts a schematic diagram of an exemplary bench-scale foam fractionation system.

FIG. 1B depicts a schematic diagram of an exemplary bench-scale foam fraction system.

FIG. 2A: Surface tension of four surfactants as a function of concentration in solution.

FIG. 2B: Predicted surface excess for each surfactant from the Langmuir-Szyszkowski equation.

FIG. 3A: Control experiment to determine baseline a) long-chain PFAS removal from 10 mM NaCl solution without the addition of a co-surfactant.

FIG. 3B: Control experiment to determine baseline short-chain PFAS removal from 10 mM NaCl solution without the addition of a co-surfactant.

FIG. 4A: Removal of long-chain PFAS by foam fractionation with addition of Saponin.

FIG. 4B: Removal of short-chain PFAS by foam fractionation with addition of Saponin.

FIG. 5A: Removal of long-chain PFAS by foam fractionation with addition of Tween 80.

FIG. 5B: Removal of short-chain PFAS by foam fractionation with addition of Tween 80.

FIG. 6A: Removal of long-chain PFAS by foam fractionation with addition of NDZS.

FIG. 6B: Removal of short-chain PFAS by foam fractionation with addition of NDZS.

FIG. 6C: Summary of removal of PFOS and PFOA by foam fractionation with SBDS at pH 3, 5, and 6.57.

FIG. 6D: Summary of removal of PFBS and PFBA by foam fractionation with SBDS at pH 3, 5, and 6.57

FIG. 7A: Removal of PFOS and PFOA by foam fractionation with NDZS with no pH adjustment (pH=6.57).

FIG. 7B: Removal of PFBS and PFBA by foam fractionation with NDZS with no pH adjustment (pH=6.57).

FIG. 7C: Total PFAS remaining in groundwater during foam fractionation with SBDS adjusted to pH 3.

FIG. 8A: Removal of PFOA and PFOS by foam fractionation with NDZS adjusted to pH=

5.

FIG. 8B: Removal of PFBS and PFBA by foam fractionation with NDZS adjusted to pH=5.

FIG. 8C: Comparison of total PFAS removal with CTAB and SBDS adjusted to pH=3 by foam fractionation operating under similar experimental conditions.

FIG. 8D: Surface excess at low concentrations for CTAB and SBDS based on fitting of L/S equation.

FIG. 9A: Removal of PFOS and PFOA by foam fractionation with NDZS adjusted to pH=3.

FIG. 9B: Removal of PFBS and PFOA by foam fractionation with NDZS adjusted to pH=3.

FIG. 10: Summary of PFBS and PBFA removal by foam fractionation with NDZS at pH 3, 5, and 6.57.

FIG. 11: Total PFAS remaining in groundwater during foam fractionation with NDZS adjusted to pH 3.

FIG. 12A: Comparison of total PFAS removal with CTAB and NDZS adjusted to pH=3 by foam fractionation operating under similar experimental conditions.

FIG. 12B: Surface excess at low concentrations for CTAB and NDZS based on fitting of L/S equation.

FIG. 13A: Fatty acid composition by carbon chain length found in shea^{3,4}.

FIG. 13B: Fatty acid composition by carbon chain length found in coconut⁵.

FIG. 14: Schematic diagram of foam fractionation apparatus.

FIG. 15: Removal of PFOS, PFOA, PFBS, and PFBA from synthetic groundwater by foam fractionation with addition of SBATC at a rate of 1.0 mg/min for the duration of the experiment. Points represent average concentration between the two sampling ports, and the error bars represent the standard deviation of six samples (triplicate samples from upper and lower sampling ports). Initial PFAS concentrations (ng/L): PFBA (44,266±1,495), PFBS (36,701±928), PFOA (39,314±1,535), PFOS (38,334±1,359).

FIG. 16: Removal of PFBA after addition of CTAB, SBATC and SBAB co-surfactants to the foam fractionation system with synthetic groundwater containing PFOS, PFOA, PFBS, and PFBA. Initial PFAS concentrations (ng/L) SBATC: PFBA (44,266±1,495), PFBS (36,701±928), PFOA (39,314±1,535), PFOS (38,334±1,359); Initial PFAS concentrations (ng/L) CTAB: PFBA (44,581±227), PFBS (38,857±271), PFOA (42,856±1,887), PFOS (35,576±1,058); Initial PFAS concentrations (ng/L) SBAB pH 3: PFBA (43,705±554), PFBS (44,740±1,053), PFOA (40,524±991), (33,381±2,709).

FIG. 17: Surface tension of cationic surfactant solutions (CTAB, SBATC, BHC) as a function of concentrations in synthetic groundwater (21.5±1 °C).

FIG. 18: Removal of PFOS, PFOA, PFBS, and PFBA from synthetic groundwater by foam fractionation with addition of BHC at a rate of 1.0 mg/min. Data points are average concentration between the sampling ports and the error bars represent the standard deviation of six samples (triplicate samples from upper and lower sampling ports). Initial PFAS concentrations (ng/L): PFBA (44,479±747), PFBS (38,837±1,827), PFOA (43,508±972), PFOS (31,455±1,226).

FIG. 19A: Volume Reduction Factor (VRF) for foam fractionation experiments conducted with CTAB, SBATC, and BHC at a dosing rate of 1.0 mg/min. Initial PFAS concentrations (ng/L) SBATC: PFBA (44,266±1,495), PFBS (36,701±928), PFOA (39,314±1,535), PFOS (38,334±1,359); Initial PFAS concentrations (ng/L) CTAB: PFBA (44,581±227), PFBS (38,857±271), PFOA (42,856±1,887), PFOS (35,576=1,058); Initial PFAS concentrations (BHC): PFBA (44,479±747), PFBS (38,837±1,827), PFOA (43,508±972), PFOS (31,455±1,226).

FIG. 19B: Foam collected for foam fractionation experiments conducted with CTAB, SBATC, and BHC at a dosing rate of 1.0 mg/min. Initial PFAS concentrations (ng/L) SBATC: PFBA (44,266±1,495), PFBS (36,701±928), PFOA (39,314±1,535), PFOS (38,334±1,359); Initial PFAS concentrations (ng/L) CTAB: PFBA (44,581±227), PFBS (38,857±271), PFOA (42,856±1,887), PFOS (35,576±1,058); Initial PFAS concentrations (BHC): PFBA (44,479±747), PFBS (38,837±1,827), PFOA (43,508±972), PFOS (31,455±1,226).

FIG. 20A: Removal of PFAS from AFFF-impacted groundwater with CTAB introduced at a rate of 1.0 mg/min for the duration of the experiment (21.5±1 °C). Initial PFAS concentrations (ng/L): PFBA (302.1±20.9), PFPeA (925.7±64.5), PFHxA (908.9±76.9), PFHpA (467.7±32.4), PFOA (1,578.8±158.7), PFNA (194.4±9.64), PFBS (559.4±2.27), PFHxS (3242.4±246.9), PFHpS (98.9±5.9), PFOS (5,094.3±497.6), 6:2 FTS (827.9±73.2).

FIG. 20B: Removal of PFAS from AFFF-impacted groundwater with SBATC introduced at a rate of 1.0 mg/min for the duration of the experiment (21.5±1 °C). Initial PFAS concentrations (ng/L): PFBA (302.1±20.9), PFPeA (925.7±64.5), PFHxA (908.9±76.9), PFHpA (467.7±32.4), PFOA (1,578.8±158.7), PFNA (194.4±9.64), PFBS (559.4±2.27), PFHxS (3242.4±246.9), PFHpS (98.9±5.9), PFOS (5,094.3±497.6), 6:2 FTS (827.9±73.2).

FIG. 21A: Removal of PFOS, PFOA, PFBS, and PFBA from synthetic groundwater by foam fractionation with addition of SBATC at a dosing rate of 0.5 mg/min. Data points are average concentration between the sampling ports and error bars represent standard deviation of six samples (triplicate samples from upper and lower sampling ports). Initial PFAS concentrations (ng/L) panel a): PFBA (40,331±1,244), PFBS (38,058±685), PFOA (39,831±2,053), PFOS (33,192±584)|Initial PFAS concentrations (ng/L) panel b): PFBA (38,499±603), PFBS (34,285±1,558), PFOA (39,113±680), PFOS (32,534±1,497).

FIG. 21B: Removal of PFOS, PFOA, PFBS, and PFBA from synthetic groundwater by foam fractionation with addition of SBATC at a dosing rate of 0.1 mg/min. Data points are average concentration between the sampling ports and error bars represent standard deviation of six samples (triplicate samples from upper and lower sampling ports). Initial PFAS concentrations (ng/L) panel a): PFBA (40,331±1,244), PFBS (38,058±685), PFOA (39,831±2,053), PFOS (33,192±584)|Initial PFAS concentrations (ng/L) panel b): PFBA (38,499±603), PFBS (34,285±1,558), PFOA (39,113±680), PFOS (32,534±1,497).

FIG. 22A: Normalized cell viability of Caco-2 following incubation with surfactants for 24 hours. Data are presented as average #standard deviation. One-way ANOVA with Tukey's post-hoc analysis was used to compare the effect of all surfactant concentrations; n=3 biological replicates with 3 technical replicates; α=0.05. Different letters indicate significantly different values (p<0.05).

FIG. 22B: Normalized cytotoxicity measured via release of intracellular enzyme LDH for Caco-2 after 24-hour incubation with surfactants. Data are presented as average±standard deviation. One-way ANOVA with Tukey's post-hoc analysis was used to compare the effect of all surfactant concentrations; n=3 biological replicates with 3 technical replicates; α=0.05. Different letters indicate significantly different values (p<0.05).

FIG. 23A: Normalized cell viability of ZFL following incubation with surfactants for 24 hours, as measured through AB. Data are presented as average±standard deviation. One-way ANOVA with Tukey's post-hoc analysis was used to compare all concentrations; n=3 biological replicates with 5 technical replicates; α=0.05. Different letters indicate significantly different values (p<0.05).

FIG. 23B: Normalized cell viability of ZFL following incubation with surfactants for 24 hours, as measured through CFDA-AM. Data are presented as average #standard deviation. One-way ANOVA with Tukey's post-hoc analysis was used to compare all concentrations; n=3 biological replicates with 5 technical replicates; α=0.05. Different letters indicate significantly different values (p<0.05).

### DETAILED DESCRIPTION

The present invention provides a method for decontaminating water containing one or more PFAS contaminants, using foam fractionation to remove a PFAS contaminant from a water source, the method comprising: (a) injecting a foaming agent, a surfactant, or a mixture thereof into an active column; (b) providing a feed stream to an inlet of the active column, wherein the feed stream comprises the PFAS contaminated water; (c) introducing the feed stream into an interior of the active column; (d) injecting a gas through a diffuser and into the water so as to form a plurality of bubbles in the PFAS contaminated water; (e) the plurality of gas bubbles in the feed stream, forming a foam layer, wherein (i) the foam layer is situated atop the feed stream in the interior of the active column, (ii) the foam layer comprises majority of the PFAS contaminant, and (iii) after the foam layer is formed, the interior of the active column comprises the foam layer and a purified stream; (f) collecting the foam layer by subjecting the active column under reduced pressure and disposing the foam layer; (g) passing the purified stream into a next column, wherein the next column operates as the active column and the purified stream operates as the feed stream; (f) continuously repeating steps (b) through (g) until the feed stream becomes a cleaned stream, wherein a cleaned stream comprises water with a concentration of PFAS contaminants are below a final desired concentration of the PFAS contaminant.

A preferred embodiment provides a method wherein the PFAS are long chain and short chain PFAS.

Another preferred embodiment provides a method wherein the foaming agent is selected from Saponin, Tween 80, cyclodextrin, aloe vera, amino-sensly, a naturally derived zwitterionic surfactant (NDZS) and shea butter derived surfactant (SBDS), or a mixture thereof. It is to be understood that the terms naturally derived zwitterionic surfactant (NDZS) and shea butter derived surfactant (SBDS) can be used interchangeably and refer to a naturally derived zwitterionic surfactant from shea butter material, preferably with a cationic charge when used as a surfactant. Accordingly, the present disclosure will make reference to “NDZS/SBDS”.

Another preferred embodiment provides a method wherein the gas is air comprising more than 80% nitrogen. A further preferred aspect of this embodiment provides a method wherein the air comprises more than 90% nitrogen.

Another preferred embodiment provides a method wherein the foaming agent is a naturally derived zwitterionic surfactant (NDZS/SBDS).

Another preferred aspect of the present invention provides a method wherein the foam is collected from the surface of the water by a foam capturing device that is in communication with a vacuum source.

Yet another preferred embodiment provides a method comprising adding an effective amount of a surfactant to one or more of the feed streams and the purified stream.

A preferred embodiment provides a method wherein the concentration of the long chain and short chain PFAS contaminant in the cleaned stream of water is less than 1% from their initial concentration in the water.

Another preferred embodiment provides a method wherein the concentration of the long chain and short chain PFAS contaminant in the cleaned stream of water is less than the limit of detection for each of the identified PFAS.

The present invention provides a method of decontaminating PFAS contaminated water containing one or more PFAS contaminants, the method comprising decontaminating the PFAS contaminated water using a non-toxic surfactant.

A preferred embodiment provides a method wherein the PFAS contaminants are long chain, short chain PFAS or a mixture thereof, and the non-toxic surfactant is a naturally derived zwitterionic (NDZS/SBDS) or cationic surfactant. According to one aspect, exemplary surfactants described herein exclude CTAB or CTAC. Another preferred embodiment provides a method wherein the PFAS contaminants comprise at least one of perfluorooctanoic acid (PFOA), perfluorooctanesulfonic acid (PFOS), perfluorohexanesulfonic acid (PFHxS), perfluorononanoic acid (PFNA), perfluorodecanoic acid (PFDA), perfluoroundecanoic acid (PFUnA), perfluorododecanoic acid (PFDoA), nanofluoro-1-butanesulfonic acid potassium salt (PFBS), Perfluorobutanesulfonic acid potassium salt (PFBS) and Perfluorobutanoic acid (PFBA).

A further preferred embodiment provides a method wherein the non-toxic surfactant is selected from a surfactant derived from shea butter, shea butter-based material, canola oil, mango butter, kokum butter, cocoa butter, jojoba oil, avocado oil, almond oil, coconut butter, cupuacu butter, macadamia butter, olive butter, a mixture thereof, or a chemical equivalent thereon. A “surfactant derived from” as understood in the present disclosure refers to a surfactant that is synthesized from the fatty acid or fatty acids present in a natural plant-based material and as further described herein, such that the natural plant-based material is the starting material for synthesis of the surfactant compounds described herein. However, it is to be understood that the surfactants described herein can be made from purified fatty acids that may be commercially available and the surfactant compounds themselves may be commercially available. A further preferred embodiment provides a method wherein the water is decontaminated at a pH of from about 3 to about 7 using a foam fractionation process, active carbon filters, reverse osmosis, UV purification, distillation, ceramic filters, ion exchange resins, portable water purifiers, gravity-based filters, under the cabinet water purifier systems, electro-chemical systems, coagulation and flocculation, bio-reactors, constructed wetlands, or a combination thereof.

Provided in yet another preferred embodiment is a method wherein the foam fractionation process comprises generating foam in the PFAS contaminated water at a pH from about 3 to about 7. A further preferred aspect of this embodiment provides a method wherein foam is generated by mechanically agitating the PFAS contaminated water, aerating a gas through the PFAS contaminated water, or bubbling a gas through the PFAS contaminated water, and wherein the gas comprises air, nitrogen, oxygen, carbon dioxide, or a combination thereof.

Yet another preferred embodiment provides a method wherein the method further comprises collecting the foam containing the one or more PFAS contaminants, and separating the collected foam to obtain a PFAS free concentrate and treated water.

Yet another preferred embodiment provides a method wherein the water is decontaminated using a whole house decontamination system, foam fractionation, a counter top decontamination system, portable water purifier system, faucet mounted water decontamination system, municipal water filtration systems, or a combination thereof.

Another embodiment provides a method wherein the water is sourced from surface water, ground water, well water, rain water, desalinated water, glacial and ice melt water, soft water, hard water, or a combination thereof. Yet another embodiment provides a method wherein the foam fractionation unit comprises a column or a tank. A particularly preferred embodiment provides a method wherein the non-toxic surfactant may be derived from shea butter, canola oil, or a naturally occurring or a synthetic equivalent thereof.

Another aspect of the present invention provides a method wherein pretreating comprises at least one of pH adjustment, coagulation, agitation, flocculation, sedimentation, filtration, or a combination thereof.

Provided in another aspect of the present invention is a method wherein the PFAS contaminated water is from an environmental source. A preferred aspect of this embodiment provides a method wherein the environmental source comprises groundwater, surface water, wastewater, or a combination thereof.

Another aspect of the present invention provides a method wherein the PFAS contaminated water has a total PFAS concentration of about 0.01 ng/L to about 100,000 ng/L prior to the foam fractionation process. A further preferred aspect provides a method wherein the decontaminated water has a total PFAS concentration of about 0.01 ng/L to about 70 ng/L after the foam fractionation process.

Another aspect of the present invention provides a method wherein the foam fractionation process removes about 50% to about 99.9% of the one or more PFAS contaminants from the PFAS contaminated water.

Provided in another embodiment of the present invention is a method wherein the foaming agent is a naturally derived zwitterionic or cationic surfactant (NDZS/SBDS). Another preferred embodiment provides a method wherein the foaming agent is a non-toxic surfactant derived from a shea butter-based material, shea butter, canola oil, mango butter, kokum butter, cocoa butter, almond oil, coconut butter, cupuacu butter, macadamia butter, olive butter, a mixture thereof, or a chemical equivalent thereon.

Another preferred embodiment of the present invention provides a method of decontaminating PFAS contaminated water containing one or more PFAS contaminants, the method comprising decontaminating the PFAS contaminated water using a non-toxic surfactant, said method further comprising (a) injecting a foaming agent, a surfactant, or a mixture thereof into an active column; (b) providing a feed stream to an inlet of the active column, wherein the feed stream comprises the PFAS contaminated water at a pH of from about 3 to about 7; (c) introducing the feed stream into an interior of the active column; (d) injecting a gas through a diffuser and into the water so as to form a plurality of bubbles in the PFAS contaminated water; (e) the plurality of gas bubbles in the feed stream, forming a foam layer, wherein (i) the foam layer is situated atop the feed stream in the interior of the active column, (ii) the foam layer comprises majority of the PFAS contaminant, and (iii) after the foam layer is formed, the interior of the active column comprises the foam layer and a purified stream; (f) collecting the foam layer by subjecting the active column under reduced pressure and disposing the foam layer; (g) passing the purified stream into a next column, wherein the next column operates as the active column and the purified stream operates as the feed stream; (f) continuously repeating steps (b) through (g) until the feed stream becomes a cleaned stream, wherein a cleaned stream comprises water with a concentration of PFAS contaminants are below a final desired concentration of the PFAS contaminant.

A preferred aspect of this embodiment provides a method wherein the foaming agent is a naturally derived zwitterionic or cationic surfactant (NDZS/SBDS). A further preferred aspect provides a method wherein the foaming agent is a non-toxic surfactant selected from a surfactant derived from shea butter, shea butter-based material, canola oil, mango butter, kokum butter, cocoa butter, almond oil, coconut butter, cupuacu butter, macadamia butter, olive butter, a mixture thereof, or a chemical equivalent thereon, and wherein the PFAS contaminants comprise at least one of perfluorooctanoic acid (PFOA), perfluorooctanesulfonic acid (PFOS), perfluorohexanesulfonic acid (PFHxS), perfluorononanoic acid (PFNA), perfluorodecanoic acid (PFDA), perfluoroundecanoic acid (PFUnA), perfluorododecanoic acid (PFDoA), nanofluoro-1-butanesulfonic acid potassium salt (PFBS), Perfluorobutanesulfonic acid potassium salt (PFBS), and Perfluorobutanoic acid (PFBA).

Another embodiment provides a method wherein the air comprises at least 80% nitrogen. Yet another preferred aspect provides a method wherein the foaming agent is a naturally derived zwitterionic surfactant (NDZS/SBDS). A further preferred aspect of this embodiment provides a method wherein the foam is collected from the surface of the water by a foam capturing device that is in communication with a vacuum source.

Yet another preferred embodiment provides a method further comprising adding an effective amount of a surfactant to one or more of the feed streams and the purified stream. Provided in another preferred embodiment is a method wherein the concentration of the long chain and short chain PFAS contaminant in the cleaned stream of water is less than about 2% from their initial concentration in the water. A further preferred aspect of this embodiment provides a method wherein the concentration of the long chain and short chain PFAS contaminant in the cleaned stream of water is less than about 1% from their initial concentration in the water.

The present invention also provides a method for purifying PFAS contaminated water, the method comprising contacting the PFAS contaminated water with a surfactant at a pH ranging from about 3 to about 7, wherein the surfactant removes PFAS from the PFAS contaminated water, thereby purifying the PFAS contaminated water.

A preferred embodiment provides a method wherein the surfactant comprises at least one of an anionic surfactant, a cationic surfactant, a nonionic surfactant, or an amphoteric surfactant and the PFAS are short chain or long chain PFAS.

Another preferred embodiment provides a method wherein the surfactant is present in an amount of about 0.01 weight % to about 10 weight % based on the total weight of the PFAS contaminated water.

Provided in another embodiment is method wherein the contacting is performed at a temperature of about 10 °C to about 100 °C. A preferred aspect of this embodiment provides a method wherein the contacting is performed for a time period of about 1 minute to about 24 hours.

Another preferred embodiment provides a method further comprising separating the surfactant from the purified water after the contacting step. A preferred aspect of this embodiment provides a method wherein the separating is performed by at least one of filtration, centrifugation, or decantation.

Yet another preferred embodiment provides a method wherein the PFAS contaminants comprise at least one of perfluorooctanoic acid (PFOA), perfluorooctanesulfonic acid (PFOS), perfluorohexanesulfonic acid (PFHxS), perfluorononanoic acid (PFNA), perfluorodecanoic acid (PFDA), perfluoroundecanoic acid (PFUnA), perfluorododecanoic acid (PFDoA), nanofluoro-1-butanesulfonic acid potassium salt (PFBS), Perfluorobutanesulfonic acid potassium salt (PFBS), and Perfluorobutanoic acid (PFBA). Per- or polyfluoroalkyl substances (PFAS) referred to herein are known to those of skill in the art and includes those tested for as described in EPA Method 1633 incorporated herein by reference.

Per- and polyfluoroalkyl substances are a group of synthetic organofluorine chemical compounds that have multiple fluorine atoms attached to an alkyl chain. The United States Environmental Protection Agency (EPA) defines PFAS in the Drinking Water Contaminant Candidate List 5 as substances that contain “at least one of the following three structures: R—CF₂—CF(R′)R”, where both the —CF₂— and —CF— moieties are saturated carbons, and none of the R groups can be hydrogen; R—CF₂—O—CF₂—(R′), where both the —CF₂— moieties are saturated carbons, and none of the R groups can be hydrogen; or CF₃—C—(CF₃)RR′, where all the carbons are saturated, and none of the R groups can be hydrogen. According to one aspect a PFAS compound has an anionic charge. Fluorinated surfactants or fluorosurfactants are a subgroup of PFAS characterized by a hydrophobic fluorinated “tail” and a hydrophilic “head” that behave as surfactants. These are more effective at reducing the surface tension of water than comparable hydrocarbon surfactants.

Fluorosurfactants tend to concentrate at the phase interfaces. Fluorocarbons are both lipophobic and hydrophobic, repelling both oil and water. Their lipophobicity results from the relative lack of London dispersion forces compared to hydrocarbons, a consequence of fluorine's large electronegativity and small bond length, which reduce the polarizability of the surfactants' fluorinated molecular surface. Fluorosurfactants are more stable than hydrocarbon surfactants due to the stability of the carbon-fluorine bond. Exemplary fluorosurfactants include PFOS, PFOA, and perfluorononanoic acid (PFNA). Exemplary PFAS compounds within the scope of the present disclosure are provided in the Table 1 below.

TABLE 1

| Compound Name | Abbreviation | CAS |
|---|---|---|
| Perfluorobutanoic acid | PFBA | 375-22-4 |
| Perfluoropentanoic acid | PFPeA | 2706-90-3 |
| Perfluorohexanoic acid | PFHxA | 307-24-4 |
| Perfluoroheptanoic acid | PFHpA | 375-85-9 |
| Perfluorooctanoic acid | PFOA | 335-67-1 |
| Perfluorononanoic acid | PFNA | 375-95-1 |
| Perfluorodecanoic acid | PFDA | 335-76-2 |
| Perfluoroundecanoic acid | PFUnA | 2058-94-8 |
| Perfluorododecanoic acid | PFDoA | 307-55-1 |
| Perfluorotridecanoic acid | PFTrDA | 72629-94-8 |
| Perfluorotetradecanoic acid | PFTeDA | 376-06-7 |
| Perfluorobutanesulfonic acid | PFBS | 375-73-5 |
| Perfluoropentanesulfonic acid | PFPeS | 2706-91-4 |
| Perfluorohexanesulfonic acid | PFHxS | 355-46-4 |
| Perfluoroheptanesulfonic acid | PFHpS | 375-92-8 |
| Perfluorooctanesulfonic acid | PFOS | 1763-23-1 |
| Perfluorononanesulfonic acid | PFNS | 68259-12-1 |
| Perfluorodecanesulfonic acid | PFDS | 335-77-3 |
| Perfluorododecanesulfonic acid | PFDoS | 79780-39-5 |
| Fluorotelomer sulfonic acid 4:2 | FtS 4:2 | 757124-72-4 |
| Fluorotelomer sulfonic acid 6:2 | FtS 6:2 | 27619-97-2 |
| Fluorotelomer sulfonic acid 8:2 | FtS 8:2 | 39108-34-4 |
| Perfluorooctanesulfonamide | PFOSA | 754-91-6 |
| N-methyl perfluorooctanesulfonamide | NMeFOSA | 31506-32-8 |
| N-ethyl perfluorooctanesulfonamide | NEtFOSA | 4151-50-2 |
| 2-(N-Methylperfluorooctanesulfonamido) | NMeFOSAA | 2355-31-9 |
| acetic acid | | |
| 2-(N-Ethylperfluorooctanesulfonamido) | NEtFOSAA | 2991-50-6 |
| acetic acid | | |
| N-methyl | NMeFOSE | 24448-09-7 |
| perfluorooctanesulfonamidoethanol | | |
| N-ethyl perfluorooctanesulfonamidoethanol | NEtFOSE | 1691-99-2 |
| Hexafluoropropylene oxide dimer acid | HFPO-DA | 13252-13-6 |
| 4,8-Dioxa-3H-perfluorononanoic acid | ADONA | 919005-14-4 |
| Perfluoro-3-methoxypropanoic acid | PFMPA | 377-73-1 |
| Perfluoro-4-methoxybutanoic acid | PFMBA | 863090-89-5 |
| Nonafluoro-3,6-dioxaheptanoic acid | NFDHA | 151772-58-6 |
| 9-Chlorohexadecafluoro-3-oxanonane-1- | 9Cl-PF3ONS | 756426-58-1 |
| sulfonic acid | | |
| 11-Chloroeicosafluoro-3-oxaundecane-1- | 11Cl-PF3OUdS | 763051-92-9 |
| sulfonic acid | | |
| Perfluoro(2-ethoxyethane)sulfonic acid | PFEESA | 113507-82-7 |
| 3-Perfluoropropyl propanoic acid | 3:3FTCA | 356-02-5 |
| 2H,2H,3H,3H-Perfluorooctanoic acid | 5:3FTCA | 914637-49-3 |
| 3-Perfluoroheptyl propanoic acid | 7:3FTCA | 812-70-4 |

Also provided in a preferred embodiment is a method wherein the PFAS contaminated water has a PFAS concentration of about 0.01 ppb to about 1000 ppb prior to the contacting step.

Yet another embodiment provides a method wherein the purified water has a PFAS concentration of less than about 70 ppt after the contacting step.

The present invention also provides a method for purifying PFAS contaminated water, the method comprising contacting the PFAS contaminated water with a surfactant at a pH ranging from about 3 to about 7, wherein the surfactant removes PFAS from the PFAS contaminated water, thereby purifying the PFAS contaminated water, the method further comprising: (a) injecting a foaming agent, a surfactant, or a mixture thereof into an active column; (b) providing a feed stream to an inlet of the active column, wherein the feed stream comprises the PFAS contaminated water at a pH of from about 3 to about 7; (c) introducing the feed stream into an interior of the active column; (d) injecting a gas through a diffuser and into the water so as to form a plurality of bubbles in the PFAS contaminated water; (e) the plurality of gas bubbles in the feed stream, forming a foam layer, wherein (i) the foam layer is situated atop the feed stream in the interior of the active column, (ii) the foam layer comprises majority of the PFAS contaminant, and (iii) after the foam layer is formed, the interior of the active column comprises the foam layer and a purified stream; (f) collecting the foam layer by subjecting the active column under reduced pressure and disposing the foam layer; (g) passing the purified stream into a next column, wherein the next column operates as the active column and the purified stream operates as the feed stream; (f) continuously repeating steps (b) through (g) until the feed stream becomes a cleaned stream, wherein a cleaned stream comprises water with a concentration of PFAS contaminants are below a final desired concentration of the PFAS contaminant.

A preferred aspect of this embodiment provides a method wherein the foaming agent is a naturally derived zwitterionic (SBDS/NDZS) or cationic surfactant and the PFAS are short chain or long chain PFAS. A particularly preferred embodiment provides a method wherein the foaming agent is a non-toxic surfactant selected from a surfactant derived from shea butter, shea butter based material, canola oil, mango butter, kokum butter, cocoa butter, almond oil, coconut butter, cupuacu butter, macadamia butter, olive butter, a mixture thereof, or a chemical equivalent thereof, and wherein the PFAS contaminants comprise at least one of perfluorooctanoic acid (PFOA), perfluorooctanesulfonic acid (PFOS), perfluorohexanesulfonic acid (PFHxS), perfluorononanoic acid (PFNA), perfluorodecanoic acid (PFDA), perfluoroundecanoic acid (PFUnA), perfluorododecanoic acid (PFDoA), Perfluorobutanesulfonic acid potassium salt (PFBS), nanofluoro-1-butanesulfonic acid potassium salt (PFBS), and Perfluorobutanoic acid (PFBA).

Another embodiment provides a method wherein the gas includes ozone, nitrogen, oxygen, carbon dioxide, ambient air or gas including at least 80% nitrogen. Yet another embodiment provides a method wherein the foaming agent is a naturally derived zwitterionic surfactant (SBDS/NDZS).

A further preferred embodiment provides a method wherein the foam is collected from the surface of the water by a foam capturing device that is in communication with a vacuum source. Yet another preferred embodiment provides a method further comprising adding an effective amount of a surfactant to one or more of the feed streams.

Provided in another preferred embodiment is a method wherein the concentration of the long chain and short chain PFAS contaminant in the cleaned stream of water is less than 2% from their initial concentration in the water. A particularly preferred embodiment of this aspect provides a method wherein the concentration of the long chain and short chain PFAS contaminant in the cleaned stream of water is less than 1% from their initial concentration in the water.

### DEFINITIONS

The term “foaming agent” as used herein represents any additive to the system to assist in PFAS removal.

The term “surfactant” as used herein represents any compound with chemical properties that enhance the reduction of the surface tension of water.

The term “active column” represents a remediation system undergoing air bubble injection.

The term “ppm” represents a weight to weight ratio generally used to describe concentrations. Parts per million (ppm) is the number of units of mass of a contaminant per million units of total mass.

The term “SBDS”, as used herein is intended to represent shea butter derived, or shea butter-based, or a naturally derived zwitterionic surfactant.

The term “canola oil” as used herein is intended to represent a type of vegetable/refined edible oil derived from the seeds of the Brassica napus or Brassica rapa plants, which are cultivars of rapeseed specifically bred to be low in erucic acid (<2%) and glucosinolates. Through processes such as mechanical pressing and/or solvent extraction (commonly using hexane), followed by degumming, neutralization, bleaching, and deodorization, the crude oil is purified into the final product. It is widely used in cooking and food production because of its light flavor, high smoke point, and heart-healthy profile. Some of the key characteristics include low saturated fat content, high monounsaturated fat content fatty acid profile: ~61% monounsaturated (oleic acid), ~21% polyunsaturated (linoleic and alpha-linolenic acids), ~7% saturated fats, Omega-6 to Omega-3 ratio: Approximately 2:1, smoke point: ~204-230 °C (400-446 °F), depending on refinement level, and can contain plant sterols, tocopherols (vitamin E), and minimal trans fats if properly processed. Some of the equivalents of canola oil include sunflower oil, vegetable oil, corn oil, safflower oil, peanut oil, grapeseed oil, olive oil, avocado oil, coconut oil, and soybean oil.

The term “shea butter” as used herein is intended to represent a lipid-rich, semi-solid fat extracted from the nuts of the Vitellaria paradoxa tree (formerly Butyrospermum parkii), native to sub-Saharan Africa. It is composed primarily of triglycerides, with a high proportion of saturated and monounsaturated fatty acids. Shea butter can comprise oleic acid (C18:1) 40-60% monounsaturated, stearic acid (C18:1) 20-50%, palmitic acid (C16:0) 2-9%, linoleic acid (C18:2) 3-11%, and arachidic acid (C20:0)<1-3%. The term “shea butter” is also intended to represent a natural fat extracted from the nuts of the shea tree (Vitellaria paradoxa), native to Africa. It is an off-white to ivory-colored substance that is solid at room temperature and melts at body temperature. Rich in fatty acids (especially oleic and stearic acids) and bioactive compounds like vitamin E, triterpenes, and plant sterols, shea butter is widely used for its moisturizing, anti-inflammatory, and skin-protective properties. Some of the equivalents of shea butter include mango butter, sal butter, cocoa butter, avocado butter, illipe butter. In general, substance equivalent to shea butter will be triglyceride-based, primarily composed of C16-C18 fatty acids (palmitic, stearic, oleic, linoleic), have melting points near skin temperature, ideal for topical applications, contain unsaponifiables (sterols, tocopherols, triterpenes) that enhance skin benefits.

### Example I

### General Experimental

The present invention evaluated the performance of alternative co-foaming agents, with particular attention to biodegradable, low toxicity co-surfactants that can be used to enhance the removal of both long-chain and short-chain PFAS during foam fractionation.

A laboratory-scale foam fractionation system was used to illustrate the invention using six candidate co-foaming agents for their ability to remove long- and short-chain PFAS from water. Performance of the best candidate co-surfactant was evaluated relative to that of CTAB, and surface tension data were obtained to assess co-surfactant accumulation at the air-water interface. Based on the PFAS removal data obtained for synthetic groundwater, the best performing co-surfactant was then evaluated over a range of pH values and initial PFAS concentrations. Using the optimal pH, the performance of the selected co-surfactant was evaluated using natural groundwater collected from a military installations impacted by aqueous film forming foam (AFFF).

Materials and Methods and Reagents: Perfluorooctanoic acid (PFOA, CF₃(CF₂)₆COOH, CAS #: 335-67-1), Perflurooctanesulfonic acid potassium salt (PFOS, CF₃(CF₂)₇SO₃K, CAS #: 2795-39-3), Nanofluoro-1-butanesulfonic acid potassium salt, Perfluorobutanesulfonic acid potassium salt (PFBS, CF₃(CF₂)₃SO₃K, CAS #: 29420-49-3), and Perfluorobutanoic acid (PFBA, CF₃CF₂CF₂COOH, CAS #: 375-22-4) were all purchased from Sigma Aldrich (St. Louis, MO). Sodium Chloride (NaCl) for the experimental background matrix was purchased from Sigma Aldrich (St. Louis, MO). Cetyltrimethylammonium Bromide (CTAB, C₁₉H₄₂BrN, CAS #: 57-09-0), (2-Hydroxypropyl)-β-cyclodextrin (Cyclodextrin, CAS #128446-35-5), and TWEEN® 80 (Polysorbate nonylphenol (20) ethoxylate, CAS #: 9005-65-6) were purchased from Sigma Aldrich (St. Louis, MO). Sodium chloride and hydrochloric acid (HCl) was purchased from Fisher Scientific (Fair Lawn, NJ). AminoSensyl™ HC was purchased from Inolex (Philadelphia, PA). Saponin was purchased from Sigma Aldrich (St. Louis, MO). Aloe (CAS #: 85507-69-3) was purchased from Spectrum Chemical (New Brunswick, NJ). Methanol was purchased from Honeywell (Charlotte, NC). Internal standards and stock calibration solutions for LC-MS/MS analysis were purchased from Wellington Laboratories (Guelph, ON, Canada). All solution were prepared with ultrapure MilliQ water (18MΩ-cm). AFFF impacted groundwater was obtained from a military installation in the eastern United States. Shea butter amidopropyl betaine is commercially available from Simply Ingredients.

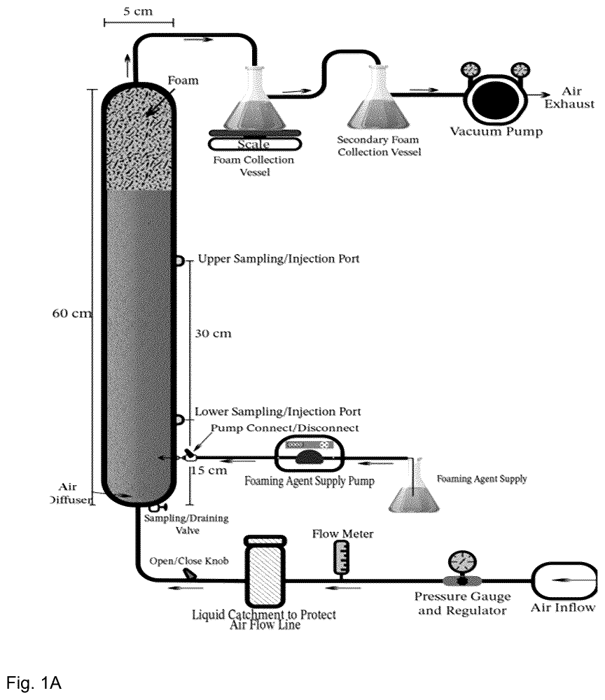

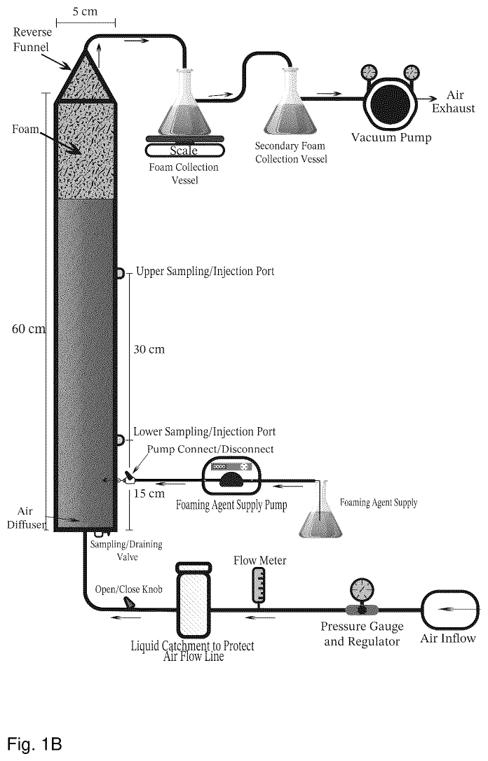

Foam Fractionation Apparatus: A schematic diagram of the bench-scale foam fractionation systems is shown in FIG. 1A. Laboratory compressed air is delivered through a pressure gauge (NOSHOK, Berea, OH), fine-tuned with a regulator (IMI Norgren, Birmingham, UK) and an air flow meter (King Instrument Company, Garden Grove CA) connected with ¼″ internal diameter flexible vacuum tubing secured with ¼″ barbed connections and a hose clamp at each junction to ensure the system remained airtight. Between the instrumentation and column, a liquid catchment was installed consisting of a 1-L bottle with barb fittings to protect the air flow line from any liquid that may enter the tubing. After traveling through the gauge, flowmeter and liquid safety, air flows into an acrylic column measuring 60 cm in height by 5 cm inner diameter (ePlastics, Coppell, TX) through an inline air diffusion stone with 0.5 μm pores that is threaded into a custom stainless-steel endplate located at the bottom of the column. The column contains sampling ports at 15 cm and 30 cm from the bottom of the column. The ports are threaded into the column and sealed with replaceable septa (QOSINA, Ronkankoma, NY) to allow for samples to be collected along the column height. To deliver co-foaming agent, an additional port is located halfway between the lower sampling port and the bottom of the column, which is equipped with a Hamilton valve (Hamilton Company, Reno, NV) connected to a Masterflex L/S® peristaltic pump (VWR, Radnor, PA). An adhesive measuring tape was placed along the height of the column to monitor changes in water and foam volumes during operation. In FIG. 1B, the top of the column was equipped with an inverted funnel connected to more vacuum tubing that leads to a series of two 1-L vacuum flasks (Fisher Scientific, Waltham, MA) connected to a vacuum pump (Welch, Ilmenau, Germany) instrumented with a vacuum gauge (Ashcroft, Stratford, CT). The flasks between the column and vacuum pump capture foam, and the first flask is placed on a scale (Mettler Toledo, Columbus, OH) to monitor foam removal rates.

Surface Tension and pH measurements: Surface tension data for the candidate co-surfactants (CTAB, Saponin, NDZS, SBDS, Tween 80) in the experimental background matrix (10 mM NaCl) were acquired utilizing a Sigma 700 precision force tensiometer (Biolin Scientific, Gothenburg, Sweden). The tensiometer is equipped with a platinum, micro-roughened Wilhelmy plate. In between each measurement, the plate was removed, rinsed with MilliQ water and methanol, and then flamed with a butane torch until shining bright red to remove traces of the previous run. All solutions for surface tension measurements were prepared in 100 mL HDPE bottles by addition of the necessary quantities of co-surfactant or PFAS to the background solution, in this case a simple 10 mM NaCl matrix. All surface tension measurements were performed at 22±1 °C in quintuplet. pH data for each solution were obtained with an Orion Star A221 pH probe (Thermo Scientific, Waltham, MA). In cases where the pH was adjusted, a cleaned magnetic stir-bar was placed in the solution and the bottle was set on a Cimarec+™ Stirring Hotplate (Thermo Scientific, Waltham, MA) and stirred at 500 rpm and the pH was lowered by dropwise addition of HCl until steady reading of the desired pH was obtained.

Foam Fractionation Experiments: Prior to each foam fractionation experiment, the column, tubing and foam collection vessels were sequentially rinsed with MilliQ water and methanol and dried. New septa and sampling syringes were used for each experiment. For experiments conducted with natural groundwater, the water was centrifuged at 4,000 rpm for 30 minutes prior to use to remove particulates. All solutions were sampled prior to use to measure the initial PFAS concentrations.

After the foam fractionation apparatus was set up, a solution containing a mixture of four PFAS (PFOS, PFOA, PFBS, PFBA) in 10 mM NaCl was added to the column to a height of 55 cm. The foam collection funnel was secured to the top of the column and simultaneously the air flow rate was set to 1 standard cubic foot per hour (SCFH), the vacuum pump was turned on and the co-foaming agent feed pump (if being used) was set to continuously dose the system to achieve foaming condition using a dosing rate of 1 mg/min. Samples were taken in triplicate from both the bottom and upper sampling ports at 0, 2, 5, 10, 15, 20, 25, and 30 minutes and then every 10 minutes until the 1 hour mark and then every 15 minutes thereafter. The system was continuously monitored for changes in air flow rate, air pressure, vacuum pressure, water and foam heights, and mass of foam collected.

Analytical Methods: Quantification of PFAS was performed using a Waters AQUITY H-Class ultra-performance liquid chromatography system (UPLC) equipped with XEVO TQ-S Micro triple quadrupole mass spectrometer (TQS). Briefly, experiments conducted with field groundwater samples were analyzed using EPA Method 1633. For experiments with synthetic groundwater containing PFOA, PFOS, PFBA, and PFBS, samples and standards were prepared with addition of an internal standard solution (10% V/V) in methanol (LC-MS grade, Honeywell, Charlotte, NC) with glacial acetic acid (1% V/V, Fisher Chemical, Fair Lawn, NJ).

### Example II

### Selection and Testing of Naturally-Derived Surfactants

Several surfactants were tested as potential co-foaming agents to assist in enhancing the removal of both long- and short-chain PFAS during foam fractionation. Tween 80 (Polysorbate 80), a nonionic surfactant used in consumer products ranging from ice cream textures to COVID-19 vaccines, was selected as a food-grade alternative co-foaming agent. β-cyclodextrin was selected because it has been studied extensively for PFAS adsorption and its chemistry can be tuned to enhance uptake of anionic molecules.

Saponins are naturally occurring surfactants typically found in plants, and it was selected because it has known soap-like qualities. NDZS/SBDS is a plant-based zwitterionic surfactant most commonly used in cosmetic formulations that is water soluble, readily biodegradable, non-sensitizing, and safe for baby and child products.

AminoSensyl™ was tested as it is a cationic surfactant made from 100% natural ingredients, readily biodegradable, and has been shown to be a suitable alternative to CTAC in cosmetic products. However, this compound is not water soluble and prior to use in the foam fractionation system, the compound was first dissolved using a stirring hotplate (Thermo Fisher, Waltham, MA) at 85 °C and 500 rpm.

Aloe vera was tested as it is also a naturally occurring compound and the structure has a negatively charged functional group and exhibits surface tension reduction. Embodiments herein are directed to the performance of the water soluble surfactants relative to CTAB, but the additional compounds were tested (Cyclodextrin, Aloe Vera, AminoSensyl™).

Many of the co-foaming agents tested are considered to be surface active and tend to accumulate at the air-water interface. Surfactants reduce the interfacial tension of water which is typically ~72 mN/m at standard temperature conditions. The reduction in interfacial tension as a function of concentration of surfactant in solution is related to the surfactant's affinity to accumulate at the air-water interface. To understand these relationships for the water-soluble surfactants tested, surface tension data was measured using a background solution consisting of 10 mM NaCl. The resulting surface tension data, including CTAB for comparison purposes, are presented in.

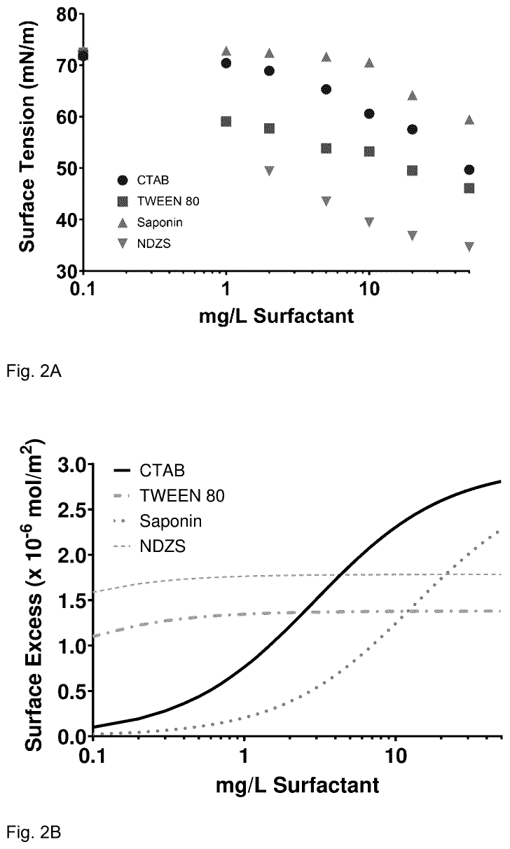

As shown in FIG. 2B, the surface excess of Tween 80 and NDZS increased rapidly at very low concentrations, as their maximum surface excess was reached at concentrations below 5 mg/L. This behavior can be beneficial if the co-surfactant can successfully remove PFAS at low concentrations as less co-surfactant would be required. However, if the co-surfactant does not remove PFAS at such low concentrations then an additional co-surfactant may be required to improve removal efficiencies.

Although the NDZS/SBDS exhibited the largest surface excess up to a concentration of 4.5 mg/L, CTAB exhibited the most accumulation at the air-water interface at higher concentrations (FIG. 2B). This relationship is important when selecting co-foaming agents for PFAS removal by foam fractionation. For example, rapid interfacial accumulation is favorable for foam formation. If foam formation does not occur soon after addition of a co-surfactant then long-chain PFAS can accumulate at the air-water interface of air bubbles and will be removed at the water surface primarily by aerosolization as opposed to foam fractionation, requiring methods to capture the aerosols. However, it should be noted that the surface excess value is not the only parameter governing the ability of a co-surfactant to remove PFAS from an aqueous matrix; the charge of the co-surfactant has also been shown to play an important role in PFAS removal efficacy.

Thus, an effective co-surfactant for PFAS foam fractionation should (a) readily accumulate at the air-water interface to generate a stable foam that can be removed and (b) possess a positive charge to attract short-chain PFAS and enhance their accumulation at the air-water interface. Moreover, an ideal co-surfactant would also be (c) readily biodegradable if released into the environment and exhibit low toxicity.

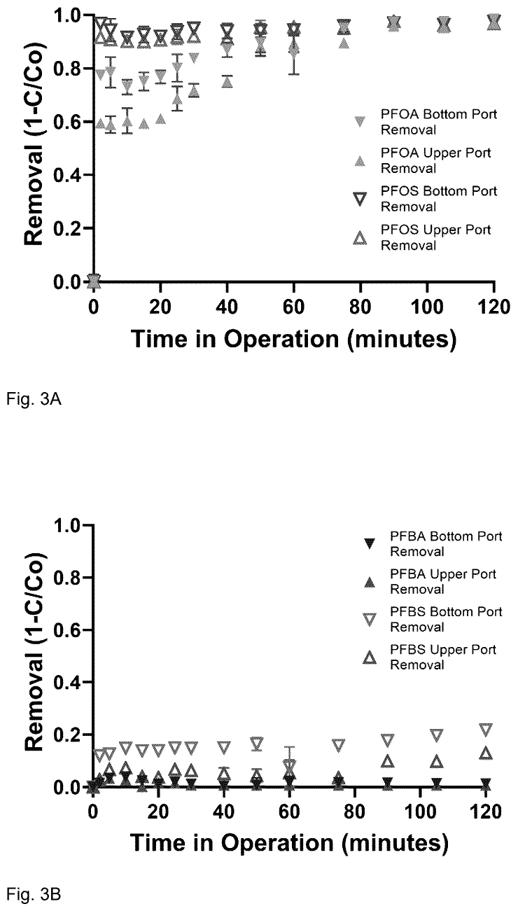

Foam Fractionation Control Experiment: Prior to testing the candidate co-surfactants, a control foam fractionation experiment was run with a mixture of PFBA, PFBS, PFOA, and PFOS, each at a concentration of ~40 μg/L. For the control experiment, no additives were introduced into the water column and the system was evaluated for removal of PFAS. To minimize effects arising from solution composition, a background matrix of 10 mM NaCl was chosen for the control experiment and initial foam fractionation tests with the co-surfactants. The long chain PFAS (PFOA and PFOS) were both completely removed from the system within 60 minutes (see FIG. 3A). PFOS exhibited more efficient removal than PFOA, which was expected due to the higher affinity of PFOS to accumulate at the air-water interface. PFBS achieved only 20% removal after 120 minutes of operation, and PFBA removal remained at zero throughout the experiment (see FIG. 3B). Also note that no foaming was observed in the control experiment, indicating that removal was due to aerosolization rather than foam fractionation.

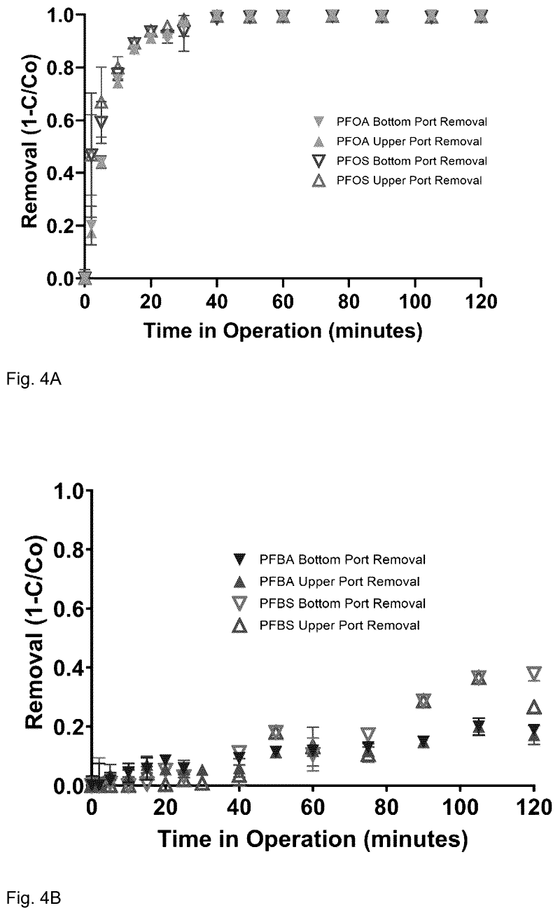

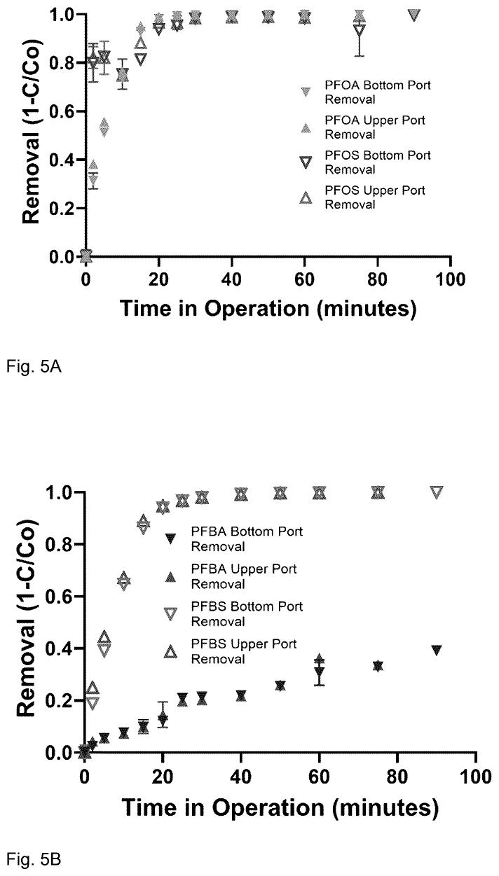

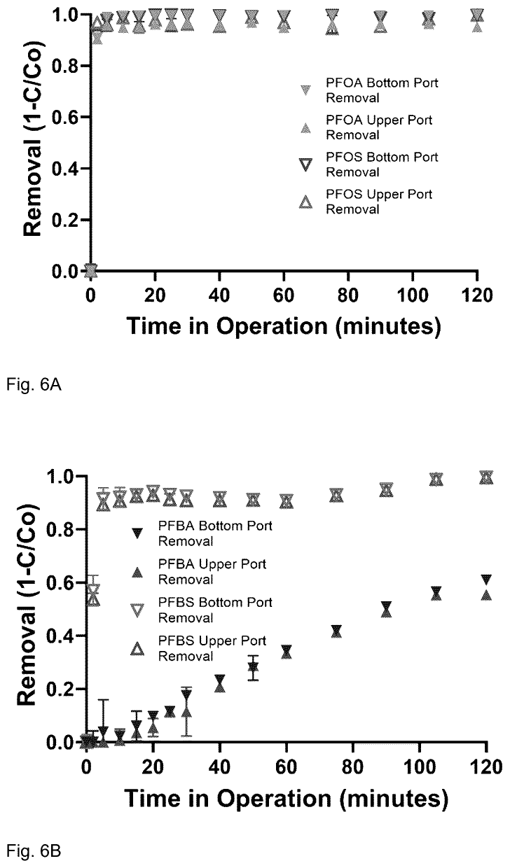

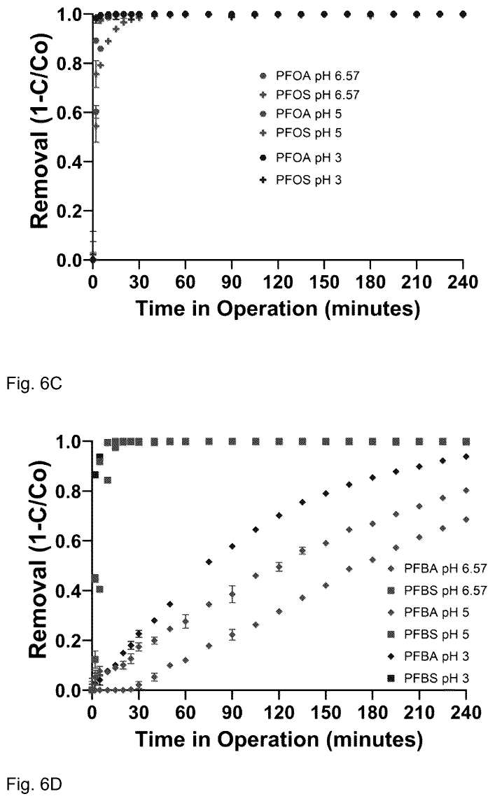

Foam Fractionation with Co-Surfactants: The ability of candidate co-surfactants to enhance the removal of a mixture of PFOA, PFOS, PFBA, and PFBS, each at a concentration of ~40 μg/L in 10 mM NaCl, was evaluated in the foam fractionation system using experimental parameters. The initial concentrations of each PFAS was measured by LC/MS-MS. The removals of long- and short-chain PFAS over the duration of each foam fractionation experiment are shown in FIG. 4A-4B, FIG. 5A-5B, and FIG. 6A-6C.

Relative to the control experiment, all of the co-surfactants tested (Saponin, Tween 80, NDZS, SBDS) yielded improved removal of PFOS and PFOA, and to a lesser extent the removal of PFBS and PFBA. Saponin (see FIG. 4A-4B) removed ~20% of PFBA and ~40% of PFBS and helped improve the removal of long chain PFAS with >99% removal of both PFOA and PFOS. Tween 80 (see FIG. 5A-5B) removed ~40% of the PFBA and achieved >99% removal of PFBS, while also enhancing efficiency for long chain PFAS removal, but the foam formed by this compound was not stable over the duration of a complete experiment. The Tween 80 system exhibited signs of disproportionation and coalescence as time progressed, leading to more drainage within the foam and reducing the ability of the vacuum to continue removing PFAS from the system.

Saponin and Tween 80 are both nonionic surfactants, while the SBDS/NDZS is a zwitterionic surfactant. The improved PFAS removal observed of NDZS/SBDS compared to nonionic surfactants is consistent with a study that studied the four different types of surfactants and their ability to remove PFAS by foam fractionation. In that study, a zwitterionic surfactant, sulfobetaine 12, removed more long- and short-chain PFAS in 60 minutes than the nonionic surfactant, Triton X-100. Another study confirmed these trends and emphasized the importance of charge of the co-surfactant as cationic and zwitterionic surfactants with opposite charges to anionic PFAS far outperformed nonionic and anionic co-surfactants. Without wishing to be bound by scientific theory, the enhanced removal mechanism is primarily due to opposing charges of the PFAS and co-surfactant through measuring the equilibrium surface tensions of the different charged co-foaming agents with and without PFOA. The surface tension of the cationic surfactant, CTAB, was reduced by >60% when an equal concentration of PFOA was added to solution while anionic, non-ionic, and zwitterionic co-surfactants had surface tension reductions of 0.9%, 1.3%, and 8.8% respectively when an equal concentration of PFOA was added to solution, indicating that the opposing charges allowed for increased surfactant concentration at the air-water interface due to their increased attracting electrostatic interactions. Several studies have exemplified the importance of opposing charges of PFAS and co-surfactant to be a major factor in enhancing removal by foam fractionation leading to CTAB/CTAC to be widely used for these purposes. Non-ionic surfactants still enhance removal of long chain surfactants as their adsorption at the air-water interface reduces surface tension leading to creation of the necessary foam. According to one aspect, surface excess is an additional factor to account for when choosing co-surfactants for enhanced PFAS removal.

SBDS/NDZS exhibited the greatest removal of short-chain PFAS of all the candidate additives, with ~57% of PFBA and >99% of PFBS removed in the two-hour run time (see FIG. 6B). The removal of the PFBS was very efficient, with over 90% removed in 5 minutes of operating time. Moreover, there was enhanced removal of PFOA and PFOS relative to the control experiment. (See FIG. 6A). The enhanced removal was consistent with the large surface excess of SBDS/NDZS calculated at low aqueous concentrations (FIG. 2B). With the SBDS/NDZS, foam formed quickly and continued throughout the experiment, allowing for easy removal via vacuum. SBDS/NDZS is derived from a natural ingredient, exhibits low toxicity and high biodegradability. For these reasons, this surfactant was selected for additional testing.

Given that SBDS is a zwitterionic surfactant, possessing both positive and negative charge, it will tend to behave more like a cationic species at lower pH. Here, as the pH is lowered there are more positive hydronium ions in solution which bind to the negative charges on the zwitterionic surfactant leaving a net positive, cationic charge. This phenomenon was explored by running the system at the ambient pH of SBDS (6.57) as well as decreasing the pH to 5.0 and 3.0. Therefore, the foam fractionation system was operated for 4 hours at pH 3.0, 5.0 and 6.57 with the addition of SBDS to determine if PFBA removal could be improved by lowering the pH and to study how long it would take for near complete PFBA removal (see FIG. 6 C and FIG. 6D).

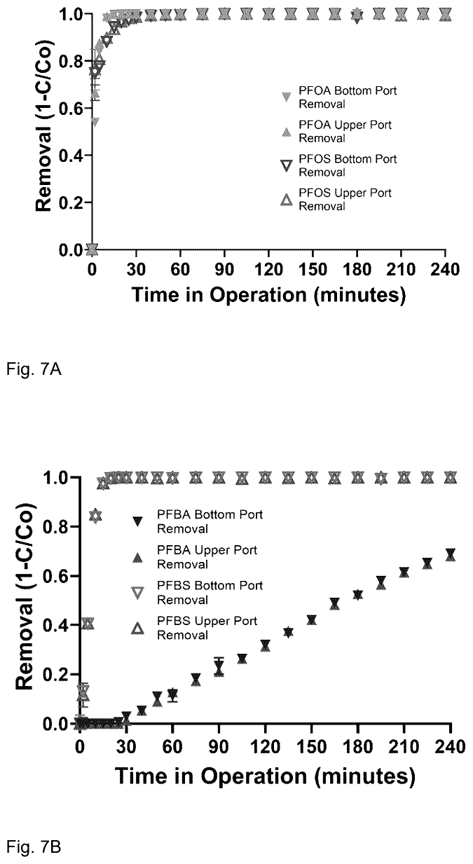

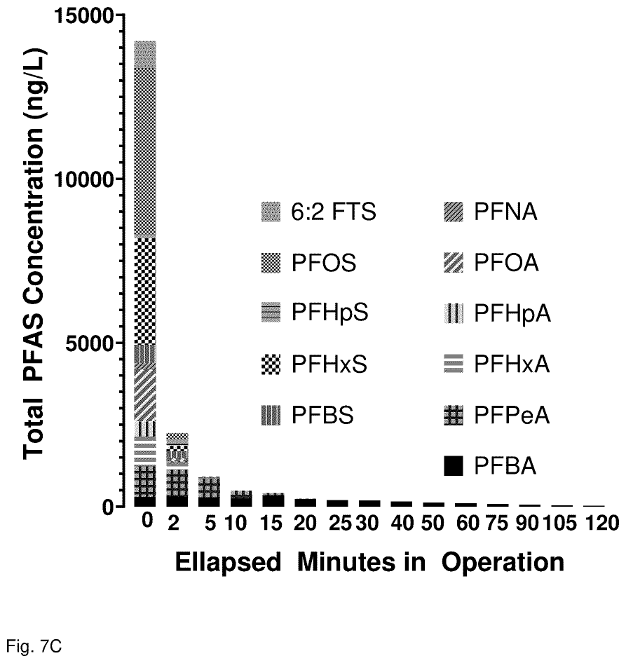

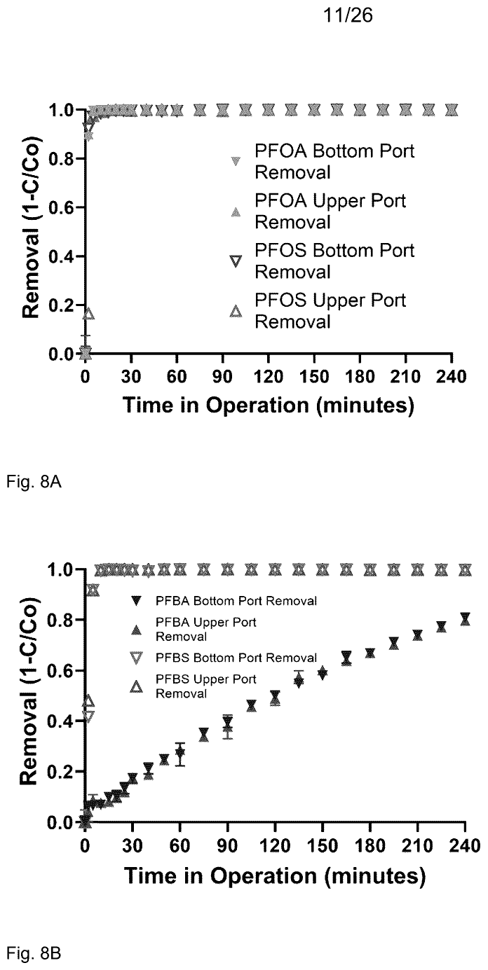

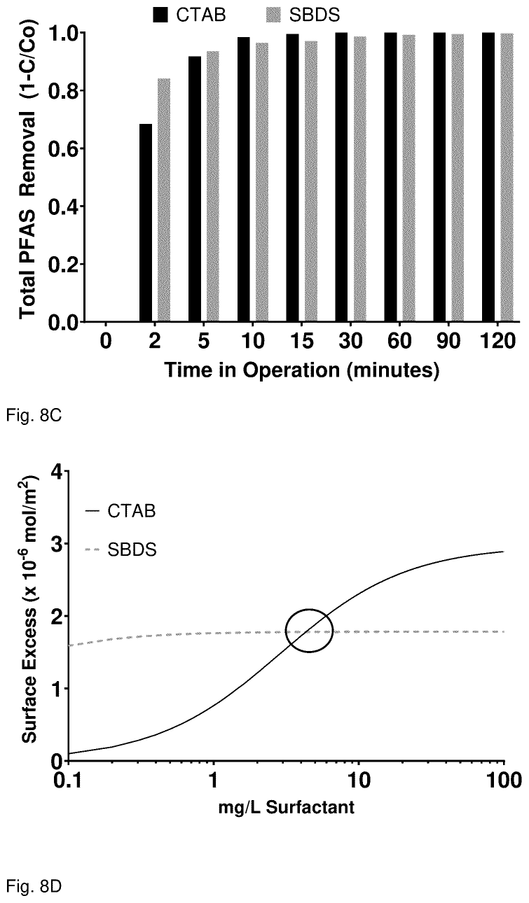

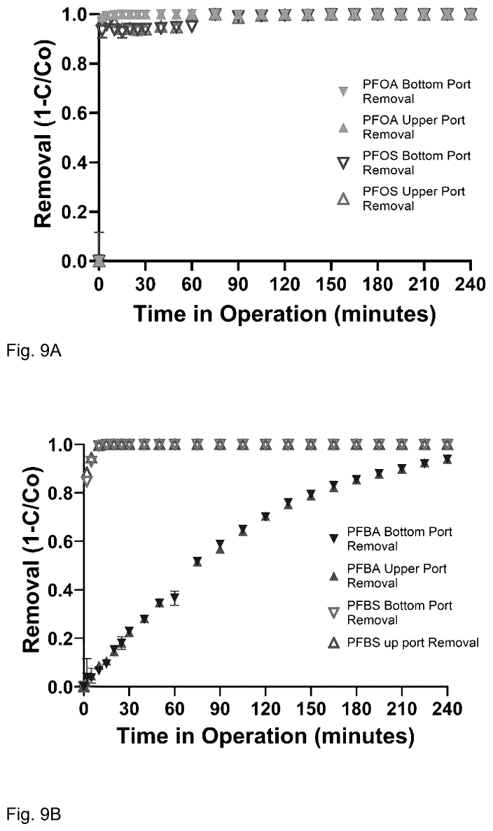

Since SBDS/NDZS is a zwitterionic surfactant, possessing both positive and negative charge, it will tend to behave more like a cationic species at lower pH. Here, as the pH is lowered there are more positive hydronium ions in solution which bind to the negative charges on the zwitterionic surfactant leaving a net positive, cationic charge. This phenomenon was explored by running the system at the ambient pH of SBDS/NDZS (6.57) as well as decreasing the pH to 5.0 and 3.0. Therefore, the foam fractionation system was operated for 4 hours at pH 3.0, 5.0 and 6.57 with the addition of SBDS/NDZS to determine if PFBA removal could be improved by lowering the pH (see FIG. 7A-7B, FIG. 8A-8B, and FIG. 9A-9B).

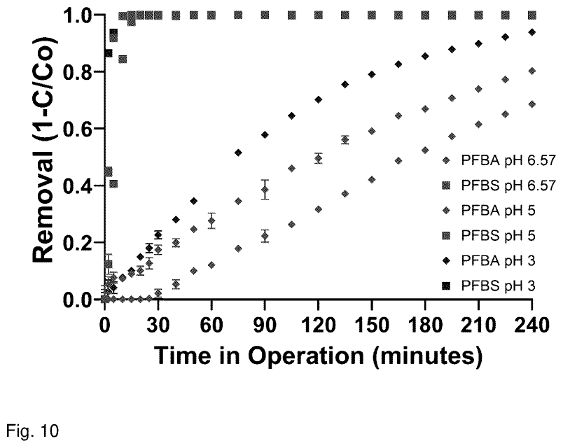

The addition of the SBDS/NDZS resulted in >99% removal of PFBS at all pH levels tested. This level of PFBS removal was achieved in less than 20 minutes with no pH adjustment and in less than 10 minutes with the pH adjusted to 5 or 3. Similarly, the removal of the PFOS and PFOA was further enhanced with pH reduction. For PFBA, removal was ~69% with no pH adjustment and improved to ~80% after adjusting the pH to 5, and then ~94% with pH lowered to 3. All three experiments achieved recoveries between 88% and 100% for PFOS, PFOA, PFBS and PFBA and enrichment factors >2. To emphasize the improvements for short-chain PFAS removal, the short-chain results are combined in FIG. 10 with the points showing the average of the top and bottom port concentrations.

While there was enrichment of each of the four PFAS, the enrichment factor was relatively low due to the long treatment times, which allowed for larger volumes of foam to be collected. There are several methods to improve the enrichment factor. A comparison of enrichment factors was carried out if the experiment was 20 minutes long as opposed to 4 hours. The recovery data suggest that the PFAS being removed is being transferred to the foam. Using the tracked volume of foam for 20 minutes and the removal data, the 20-minute enrichment factors were determined for the experiments with the SBDS. As PFOA, PFOS, and PFBS had already reached >99% removal at this time, the enrichment factors were >20× higher for these compounds at pH 3, >30× higher at unadjusted pH, and >40× higher at pH 5.

Of course, there is a tradeoff with this experimental setup as the increased enrichment of PFOA, PFOS, and PFBS for a 20-minute operation time includes minimal removal of PFBA. Often process recovery and enrichment contradict one another as high process recovery necessitates that higher volumes of foam be removed thereby decreasing the enrichment factor. The pH 5 experiment provides the highest enrichment since after 20-minutes, removals were similar, yet at pH 5, SBDS has less foam removal than the same compound at pH 3 at the same time point. It should also be noted that the experiments presented in this section employed PFAS concentrations that may be an order of magnitude higher than PFAS-impacted groundwater, so the treatment times would likely be lower for many applications.

To improve overall PFAS recovery without sacrificing the removal of compounds such as PFBA, multi-stage foam fractionation can be employed. In such configurations, the removed material undergoes secondary foam fractionation to further concentrate the PFAS in a smaller volume. After this step, a tertiary treatment can be used to concentrate the PFAS further in an even smaller volume. This process could work well with SBDS due to the large surface excess (FIG. 2B) indicating that secondary treatment, and likewise tertiary treatment, would contain ample amounts of the SBDS allowing for continued foam formation without the addition of more material.

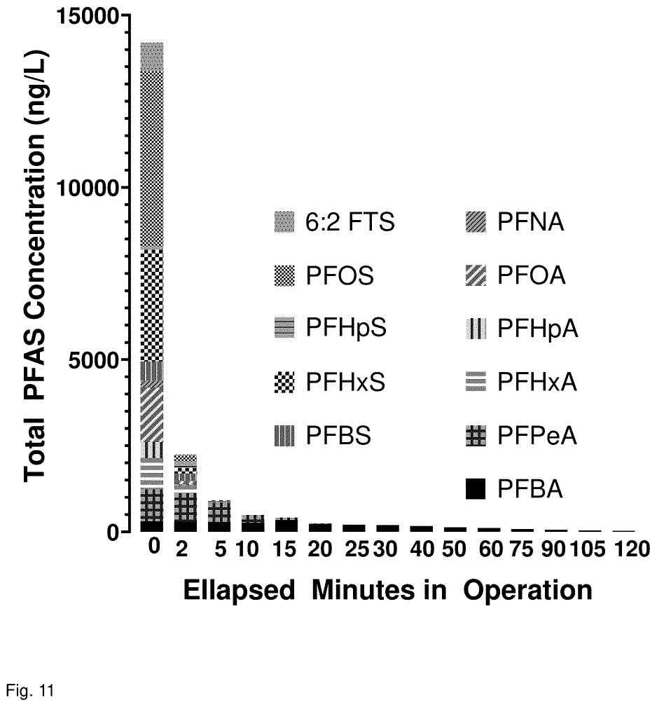

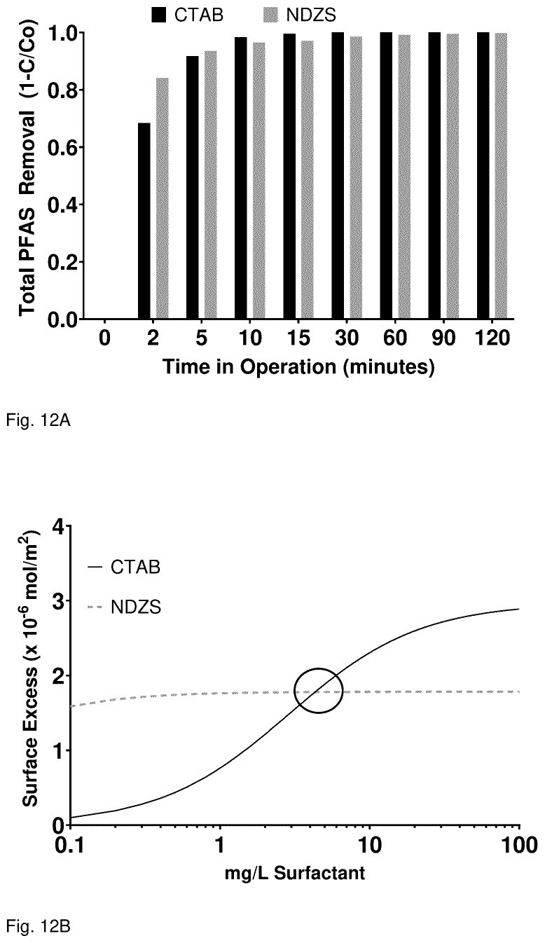

Ground Water Tests with SBDS/NDZS: To further evaluate the performance of the SBDS/NDZS, foam fractionation tests were conducted at pH 3 using PFAS impacted groundwater collected from a military installation that had used AFFF. The groundwater contained approximately 15 μg/L of total PFAS, which was dominated by PFOS and perfluorohexane sulfonic acid (PFHxS). The same groundwater was also tested utilizing CTAB to directly compare the PFAS removal results. The initial PFAS concentrations of each species detected was determined, as well as the limit of quantification (LOQ) for each of the PFAS. Additional groundwater properties were determined. All samples collected during the foam fractionation test were analyzed for PFAS based on EPA Method 1633. FIG. 11 shows the PFAS removal from the groundwater using the SBDS/NDZS. The removal performance of SBDS/NDZS relative to CTAB under similar experimental conditions are shown in FIG. 12A. All experimental parameters were consistent with the only differences between prior experiments being the pH adjustment to 3 for the SBDS/NDZS.

The performance of the SBDS, foam fractionation tests were conducted at pH 3 using PFAS impacted groundwater collected from a military installation that had used AFFF. The groundwater contained approximately 15 μg/L of total PFAS, which was dominated by PFOS and perfluorohexane sulfonic acid (PFHxS). The same groundwater was also tested utilizing CTAB to directly compare the PFAS removal results. The initial PFAS concentrations of each species detected was determined, as well as the limit of quantification (LOQ) for each of the PFAS. Additional groundwater properties were determined. All samples collected during the foam fractionation test were analyzed for PFAS based on EPA Method 1633. FIG. 7C shows the PFAS removal from the groundwater using the SBDS. The removal performance of SBDS relative to CTAB under similar experimental conditions are shown in FIG. 8C. All experimental parameters were consistent with the only difference between prior experiments being the pH adjustment to 3 for the SBDS.

Foam fractionation with CTAB addition removed all PFAS below the LOQs with 20 minutes of operation time. After 20 minutes of operation time the SBDS/NDZS removed all compounds except for PFBA, which remained above the detection limit until 120 minutes of operation time. This additional operation time may not be necessary depending on the goal of the foam fractionation. If the foam fractionation is a pretreatment method prior to using an adsorbent such as activated carbon or anion exchange resin, the additional run time may prove to be unnecessary. Secondary and tertiary treatment may also be applied to improve enrichment. Except for PFBA and perfluoropentanoic acid (PFPeA), the SBDS/NDZS was more efficient than CTAB at removing PFAS at early times. For example, after 2 minutes of operation the SBDS/NDZS removed ~84% of the total PFAS while the CTAB removed ~68%.

This behavior is consistent with the surface tension data and surface excess predictions. At the early time concentrations of the co-surfactants were in the range where the SBDS/NDZS exhibits greater interfacial accumulation than CTAB (FIG. 2B). As the volume of solution in each system is approximately 1 liter and the surfactant dosing is prescribed at a mass flux rate of 1 mg/min, the concentration in the system increases by approximately 1 mg/L-min although this number is an approximation as the foam removal will reduce the amount of surfactant in solution. As shown in FIG. 12B, more of the SBDS/NDZS will accumulate at the air-water interface compared to CTAB until the intersection point, which occurs at approximately 4.5 mg/L or approximately the equivalent in minutes of operation time for this set of foam fractionation experiments. If the mechanism enhancing PFAS removal involves ion pairing of the PFAS compound to the co-surfactant and travel together at the air-water interface, then it would be expected that the SBDS/NDZS would show increased removal relative to CTAB at early times. At concentrations as low as 0.1 mg/L SBDS/NDZS accumulates approximately 15 times greater than CTAB at the air-water interface. The maximum surface excess for SBDS/NDZS is approached at concentrations <<1 mg/L indicating that given the proper conditions, only a small amount of surfactant is necessary to achieve close to the maximum removal potential.

The surface tension data and surface excess predictions are consistent with certain behaviour. At the early time, concentrations of the co-surfactants were in the range where the SBDS exhibits greater interfacial accumulation than CTAB (see FIG. 2B). The surfactant dosing is prescribed at a mass flux rate of 1 mg/min, the concentration in the system increases by approximately 1 mg/L-min. As shown in FIG. 8D, more of the SBDS will accumulate at the air-water interface compared to CTAB until the intersection point, which occurs at approximately 4.5 mg/L. It is difficult to determine the exact concentration of the co-surfactants at any point in the experiment as they were continuously removed in the process, but since the system starts with no co-surfactant, the bulk concentrations at early time are likely in the range shown in FIG. 8D where there is greater surface excess of the SBDS compared to the CTAB. If the mechanism enhancing PFAS removal involves ion pairing of the PFAS compound to the co-surfactant and travel together at the air-water interface, then it would be expected that the SBDS would show increased removal relative to CTAB at early times. At concentrations as low as 0.1 mg/L SBDS accumulates approximately 15 times greater than CTAB at the air-water interface. The maximum surface excess for SBDS is approached at concentrations <<1 mg/L indicating that given the proper conditions only a small concentration of SBDS is necessary to keep maintained in the system for the surfactant to perform as efficiently as possible.

Since the SBDS/NDZS is zwitterionic, the pH was adjusted to optimize performance. After adjusting the pH from 6.57 to 3, this surfactant becomes more cationic, which led to improved removal of PFBA, PFBS, PFOA, and PFOS. At pH 3, the SBDS/NDZS performed as well as CTAB, and was able to remove PFAS from AFFF-impacted groundwater with similar removal efficiencies, with the exception of PFBA which took slightly longer to remove.

Although SBDS exhibits desirable properties as a co-surfactant in a PFAS foam fractionation removal system, an ideal candidate would not need the pH reduction that was required for SBDS (i.e., purely cationic). The acid required to reduce the pH introduces extra material costs, and risks and the compound is less likely to work as desired in a system containing a matrix that buffers the system to a basic pH. As more alternative surfactants are tested, the methodology presented in this work of utilizing surface excess predictions as indicators of co-surfactant excess can be employed to down select the best candidate co-surfactants.

While other studies have emphasized the importance of the charge of a co-surfactant, the present disclosure demonstrates that candidate co-surfactants should exhibit high surface excess at low concentrations and a cationic charge to quickly create stable foam and simultaneously promote the accumulation of PFAS at the air-water interface. Additionally, SBDS/NDZS is more readily biodegradable and exhibits lower toxicity compared to CTAB, minimizing potential negative impacts of any residual or accidental releases from a foam fractionation system.

### Example III

### Additional Cationic Surfactants

Aspects of the present disclosure are directed to the use of surfactants having a cationic charge, including surfactants having a cationic head or surfactants having a zwitterionic head which would include a cationic charge. Exemplary surfactants are those that are derived or otherwise made from naturally occurring fatty acids, such as those present in natural products, such as shea butter, and other natural products described herein.

According to one aspect, embodiments of the present disclosure are directed to surfactants that are nontoxic or of low toxicity to humans and/or aquatic species. Such low toxicity or no toxicity surfactants may be naturally derived from a natural source material or produced from a natural source material including fatty acids. It is to be understood that such surfactants need not be synthesized from natural materials, but that once a surfactant structure is identified, such a surfactant may be synthesized from non-natural source materials.

According to one aspect, embodiments of the present disclosure are directed to the use of natural sources of fatty acids to create positively charged surfactants having a carbon chain (referred to herein as a “tail”) and a positively charged moiety (referred to herein as a “head”.) An exemplary naturally derived surfactant within the present disclosure is shea butteramidopropyl betaine (SBAB), previously identified and described herein as either “NDZS” or “SBDS” having the structure shown below wherein R may be referred to as a shea butter group insofar as a fatty acid from shea butter may be included in shea butteramidopropyl betaine. For example, a C16-C18 carbon chain derived from a C16-C18 fatty acid found in shea butter may be included as part of the shea butteramidopropyl betaine. Shea butteramidopropyl betaine is commercially available or shea butteramidopropyl betaine may be prepared by reacting fatty acids within shea butter to create the amidopropyl betaine head group with the C16-C18 carbon tail. While shea butteramidopropyl betaine is a zwitterion having both a positive and negative charge under certain pH, shea butteramidopropyl betaine may possess a positive charge at pH under 7.

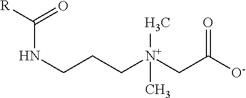

An exemplary naturally derived surfactant within the present disclosure is shea butteramidoproplytrimonium chloride (SBTAC) having the structure shown below wherein R may be referred to as a shea butter group insofar as a fatty acid from shea butter may be included in shea butteramidoproplytrimonium chloride. For example, a C16-C18 carbon chain derived from a C16-C18 fatty acid found in shea butter may be included as part of the shea butteramidoproplytrimonium chloride. Shea butteramidoproplytrimonium chloride is commercially available or shea butteramidoproplytrimonium chloride may be prepared by reacting fatty acids within shea butter to create the amidopropyltrimonium chloride head group with the C16-C18 carbon tail. According to one aspect, shea butteramidoproplytrimonium chloride has a C18 carbon tail.

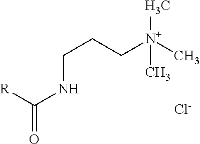

Shea butteramidopropyltrimonium chloride is a cationic surfactant derived from shea butter (Butyrospermum parkii). The molecule is composed of three main structural parts: (1) Shea Butter Amido Group: The hydrophobic tail is derived from shea butter fatty acids (primarily stearic and oleic acid, where R represents the carbon chain); (2) Propyl Group: A three-carbon chain (—CH₂CH₂CH₂—) linking the amido group to the quaternary nitrogen; (3) Trimonium Group: A quaternary trimethyl ammonium cation (—N⁺(CH₃)₃ which provides the cationic charge; and (4) Chloride: The counter-ion that balances the positive charge of the ammonium.

An exemplary naturally derived surfactant within the present disclosure is behentrimonium chloride (BHC) having the structure shown below which is derived from behenic acid in Brassica napus (rapeseed). The molecule includes a C22 carbon chain tail (from behenic acid) and a trimonium cationic head group.

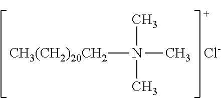

As describe herein CTAB is a petroleum derived surfactant with C16 chain length, synthesized with cetyl alcohol and dimethylamine, and was intentionally designed to function as a germicide leading to toxicity concerns. See Isomaa, B. et al., The Subacute and Chronic Toxicity of Cetyltrimethylammonium Bromide (CTAB), a Cationic Surfactant, in the Rat. Arch Toxicol 1976, 35 (2), 91-96. SBAB and SBATC are both derived from Butyrospermum parkii (shea) and used as cosmetic ingredients. See Burnett, C. L. et al., Safety Assessment of Butyrospermum parkii (Shea)-Derived Ingredients as Used in Cosmetics. Int J Toxicol 2024, 43 (1_suppl), 82S-95S. In contrast to CTAB, which has a specific single molecular structure and readily determined properties such as molecular weight, the term shea derived surfactants refer to a mixture of surfactants that may vary as a function of the fatty acid content in the feedstock material. See Garti, H. et al., Physicochemical Properties and Fatty Acid Composition of Shea Butter from Tamale, Northern Ghana, UDS International Journal of Development 2019, 6 (3), 35-40.

The synthesis of surfactants derived from shea or other similar plants starts with saponification, a process in which the triglycerides in a plant material are split into glycerol and free fatty acids. See Iwata, H. et al., Practice of Designing Cosmetics Formulations. In Formulas, Ingredients and Production of Cosmetics: Technology of Skin- and Hair-Care Products in Japan; Iwata, H., Shimada, K., Eds.; Springer Japan: Tokyo, 2013; pp 113-217. The fatty acids undergo a reaction to obtain the functional group such as the quaternization reaction that is similar to the synthesis of CTAB to obtain a positive charge useful for foam fractionation of PFAS.⁴⁹⁻⁵¹ See Prabu, S. L. et al., Chapter 5—Cleaning Validation and Its Regulatory Aspects in the Pharmaceutical Industry. In Developments in Surface Contamination and Cleaning; Kohli, R., Mittal, K. L., Eds.; William Andrew Publishing: Oxford, 2015; pp 129-186; Romero Vega, G. et al., Bio-Based Surfactants and Biosurfactants: An Overview and Main Characteristics. Molecules 2025, 30 (4), 863; Quaternization—an overview|Science Direct Topics. https://www.sciencedirect.com/topics/chemistry/quaternization (accessed 2025 Jun. 6).

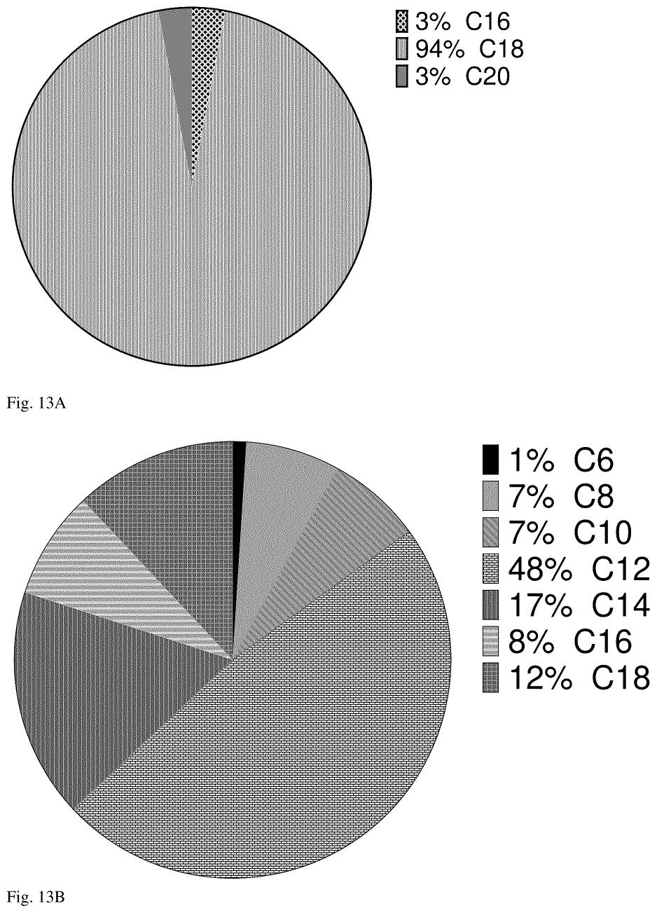

FIG. 13A shows the distribution of fatty acid chain lengths found in shea. Most of the fatty acids are C18 in length, dominated by saturated stearic acid and oleic acid, which contains an unsaturated double bond in the hydrocarbon tail. While these two fatty acids are the dominant species, the overall composition of the fatty acids may vary based on growing conditions and the geographic region in which the shea is harvested. See Di Vincenzo, D. et al., Regional Variation in Shea Butter Lipid and Triterpene Composition in Four African Countries. J. Agric. Food Chem. 2005, 53 (19), 7473-7479.

Additional naturally derived surfactants include coconut-based surfactants such as cationic cocomonium methosulfate and cocamidapropyl betainamide MEA chloride. See McCleaf, P. et al., Drinking Water Nanofiltration with Concentrate Foam Fractionation—A Novel Approach for Removal of per- and Polyfluoroalkyl Substances (PFAS). Water Research 2023, 232, 119688; Malovanyy, A. et al., Removal of Per- and Polyfluoroalkyl Substances (PFAS) from Municipal Wastewater by Foam Fractionation. Water Research 2024, 122660.

FIG. 13B shows the distribution of fatty acid chain lengths found in coconut. The primary fatty acid in coconut is lauric acid, a C12 length saturated fatty acid. See Gervajio, G. C., Fatty Acids and Derivatives from Coconut Oil. In Kirk-Othmer Encyclopedia of Chemical Technology; John Wiley & Sons, Ltd, 2012; pp 1-38. Coconut-based surfactants have been shown to improve the removal of long-chain PFAS compounds as well as PFAS with sulfonic acid head groups, but are less effective for short-chain carboxylic acids, such as PFBA and PFPeA. It has been hypothesized that shorter cationic surfactants such as DTAB exhibit strong electrostatic interactions with PFAS due to their similar sizes. While the electrostatic interactions are important, an ideal co-surfactant as described herein should also readily accumulate at the air-water interface and rapidly reduce surface tension at low concentrations. In a study comparing the relationships between surfactant chain length (C12-C18) and foam stability, the C18 surfactants rapidly reduced surface tension and produced the most stable foam. See Beneventi, D. et al., A. Role of Surfactant Structure on Surface and Foaming Properties. Colloids and Surfaces A: Physicochemical and Engineering Aspects 2001, 189 (1), 65-73.

Likewise, when comparing surface tension data for surfactants derived from lauric, stearic, and oleic acids, C18 surfactants were able to achieve the same surface tension reduction at less than a tenth of the concentration of the lauric surfactants. See Romero Vega, G. et al., Bio-Based Surfactants and Biosurfactants: An Overview and Main Characteristics. Molecules 2025, 30 (4), 863. When comparing C18 surfactants to C12, C14, and C16 surfactants, it has been shown that although the C18 surfactants had lower diffusion coefficients, the increased surface activity due to the longer chain length was the dominant reason for increased foam stability. See Bhadani, A. et al., Sustainable Oleic and Stearic Acid Based Biodegradable Surfactants. RSC Advances 2017, 7 (17), 10433-10442. According to one aspect, the longer chain length of the shea based surfactants compared to the coconut based surfactants may contribute to improved foam fractionation performance. Accordingly, the C22 chain length, cationic surfactant, Behentrimonium chloride (BHC), derived from the behenic acid in Brassica napus (rapeseed) was evaluated according to the present disclosure. The surface tension of BHC was measured over a range of concentrations, and then BHC was tested in the foam fractionation system with the identical conditions of the CTAB and SBATC studies.

According to one aspect, surfactants according to the present disclosure may have the following general structure below.
Carbon Tail-Cationic Group or Zwitterionic Group-Negatively Charged Counter Ion

The carbon tail in the general structure may include from 14 to 22 carbon atoms (C14 to C22) and may be straight chain, branched chain, saturated, unsaturated, substituted or unsubstituted. According to the present disclosure, a natural fatty acid source may be used in a reaction to form the carbon tail of the surfactant. According to one aspect, the carbon tail may be or may be derived from a species identified in Table 2 below, insofar as such a species may be used in a synthesis reaction to produce a surfactant having a hydrocarbon tail as described herein.

TABLE 2

| Category | Name | Preferred Common Name | Formula |
|---|---|---|---|
| Hydrocarbon | n-alkane (n-14 alkane) | Tetradecane | C14H30 |
| Hydrocarbon (branched) | iso-C14 alkane | iso-alkane | C14H30 |
| | (mixture) | | |
| Hydrocarbon (branched) | anteiso-C14 alkane | anteiso-alkane | C14H30 |
| | (mixture) | | |
| Hydrocarbon (mono-methyl) | 2-Methyl C13 alkane | 2-methyl-13-alkane | C14H30 |
| Hydrocarbon (mono-methyl) | 3-Methyl C13 alkane | 3-methyl-13-alkane | C14H30 |
| Hydrocarbon (mono-methyl) | 4-Methyl C13 alkane | 4-methyl-13-alkane | C14H30 |
| Hydrocarbon (mono-methyl) | 5-Methyl C13 alkane | 5-methyl-13-alkane | C14H30 |
| Hydrocarbon (mono-methyl) | 6-Methyl C13 alkane | 6-methyl-13-alkane | C14H30 |
| Hydrocarbon (mono-methyl) | 7-Methyl C13 alkane | 7-methyl-13-alkane | C14H30 |
| Hydrocarbon (mono-methyl) | 8-Methyl C13 alkane | 8-methyl-13-alkane | C14H30 |
| Hydrocarbon (mono-methyl) | 9-Methyl C13 alkane | 9-methyl-13-alkane | C14H30 |
| Hydrocarbon (mono-methyl) | 10-Methyl C13 alkane | 10-methyl-13-alkane | C14H30 |
| Hydrocarbon (mono-methyl) | 11-Methyl C13 alkane | 11-methyl-13-alkane | C14H30 |
| Fatty acid (saturated) | C14:0 saturated fatty | Myristic acid | C14H28O2 |
| | acid | | |
| Fatty acid (branched, iso) | iso-C14:0 fatty acid | iso-C14 fatty acid | C14H28O2 |
| | (mixture) | | |
| Fatty acid (branched, anteiso) | anteiso-C14:0 fatty | anteiso-C14 fatty acid | C14H28O2 |
| | acid (mixture) | | |
| Fatty acid (mono-unsaturated) | C14:1 Δ9 | Myristoleic acid | C14H26O2 |
| Fatty acid (mono-unsaturated) | C14:1 Δ9 | C14:1 (Δ9) | C14H26O2 |
| Fatty acid (mono-unsaturated) | C14:1 Δ11 | C14:1 (Δ11) | C14H26O2 |
| Fatty acid (di-unsaturated) | C14:2 Δ9, 12 | C14:2 (Δ9, 12) | C14H24O2 |
| Fatty acid (alpha-hydroxy) | 2-Hydroxy C14 fatty | 2-hydroxy C14 FA | C14H28O3 |
| | acid | | |
| Fatty acid (omega-hydroxy) | ω-Hydroxy C14 fatty | omega-hydroxy C14 FA | C14H28O3 |
| | acid | | |
| Fatty acid (2-oxo) | 2-Oxo C14 fatty acid | 2-oxo C14 FA | C14H26O3 |
| Fatty acid (omega-oxo) | ω-Oxo C14 fatty acid | omega-oxo C14 FA | C14H26O3 |
| Hydrocarbon | n-alkane (n-15 alkane) | Pentadecane | C15H32 |
| Hydrocarbon (branched) | iso-C15 alkane | iso-alkane | C15H32 |
| | (mixture) | | |
| Hydrocarbon (branched) | anteiso-C15 alkane | anteiso-alkane | C15H32 |
| | (mixture) | | |
| Hydrocarbon (mono-methyl) | 2-Methyl C14 alkane | 2-methyl-14-alkane | C15H32 |
| Hydrocarbon (mono-methyl) | 3-Methyl C14 alkane | 3-methyl-14-alkane | C15H32 |
| Hydrocarbon (mono-methyl) | 4-Methyl C14 alkane | 4-methyl-14-alkane | C15H32 |
| Hydrocarbon (mono-methyl) | 5-Methyl C14 alkane | 5-methyl-14-alkane | C15H32 |
| Hydrocarbon (mono-methyl) | 6-Methyl C14 alkane | 6-methyl-14-alkane | C15H32 |
| Hydrocarbon (mono-methyl) | 7-Methyl C14 alkane | 7-methyl-14-alkane | C15H32 |
| Hydrocarbon (mono-methyl) | 8-Methyl C14 alkane | 8-methyl-14-alkane | C15H32 |
| Hydrocarbon (mono-methyl) | 9-Methyl C14 alkane | 9-methyl-14-alkane | C15H32 |
| Hydrocarbon (mono-methyl) | 10-Methyl C14 alkane | 10-methyl-14-alkane | C15H32 |
| Hydrocarbon (mono-methyl) | 11-Methyl C14 alkane | 11-methyl-14-alkane | C15H32 |
| Hydrocarbon (mono-methyl) | 12-Methyl C14 alkane | 12-methyl-14-alkane | C15H32 |
| Fatty acid (saturated) | C15:0 saturated fatty | Pentadecanoic acid | C15H30O2 |
| | acid | | |
| Fatty acid (branched, iso) | iso-C15:0 fatty acid | iso-C15 fatty acid | C15H30O2 |
| | (mixture) | | |
| Fatty acid (branched, anteiso) | anteiso-C15:0 fatty | anteiso-C15 fatty acid | C15H30O2 |
| | acid (mixture) | | |
| Fatty acid (mono-unsaturated) | C15:1 Δ9 | C15:1 (Δ9) | C15H28O2 |
| Fatty acid (mono-unsaturated) | C15:1 Δ11 | C15:1 (Δ11) | C15H28O2 |
| Fatty acid (di-unsaturated) | C15:2 Δ9, 12 | C15:2 (Δ9, 12) | C15H26O2 |
| Fatty acid (alpha-hydroxy) | 2-Hydroxy C15 fatty | 2-hydroxy C15 FA | C15H30O3 |
| | acid | | |
| Fatty acid (omega-hydroxy) | ω-Hydroxy C15 fatty | omega-hydroxy C15 FA | C15H30O3 |
| | acid | | |
| Fatty acid (2-oxo) | 2-Oxo C15 fatty acid | 2-oxo C15 FA | C15H28O3 |
| Fatty acid (omega-oxo) | ω-Oxo C15 fatty acid | omega-oxo C15 FA | C15H28O3 |
| Hydrocarbon | n-alkane (n-16 alkane) | Hexadecane | C16H34 |
| Hydrocarbon (branched) | iso-C16 alkane | iso-alkane | C16H34 |
| | (mixture) | | |
| Hydrocarbon (branched) | anteiso-C16 alkane | anteiso-alkane | C16H34 |
| | (mixture) | | |
| Hydrocarbon (mono-methyl) | 2-Methyl C15 alkane | 2-methyl-15-alkane | C16H34 |
| Hydrocarbon (mono-methyl) | 3-Methyl C15 alkane | 3-methyl-15-alkane | C16H34 |
| Hydrocarbon (mono-methyl) | 4-Methyl C15 alkane | 4-methyl-15-alkane | C16H34 |
| Hydrocarbon (mono-methyl) | 5-Methyl C15 alkane | 5-methyl-15-alkane | C16H34 |
| Hydrocarbon (mono-methyl) | 6-Methyl C15 alkane | 6-methyl-15-alkane | C16H34 |
| Hydrocarbon (mono-methyl) | 7-Methyl C15 alkane | 7-methyl-15-alkane | C16H34 |
| Hydrocarbon (mono-methyl) | 8-Methyl C15 alkane | 8-methyl-15-alkane | C16H34 |
| Hydrocarbon (mono-methyl) | 9-Methyl C15 alkane | 9-methyl-15-alkane | C16H34 |
| Hydrocarbon (mono-methyl) | 10-Methyl C15 alkane | 10-methyl-15-alkane | C16H34 |
| Hydrocarbon (mono-methyl) | 11-Methyl C15 alkane | 11-methyl-15-alkane | C16H34 |
| Hydrocarbon (mono-methyl) | 12-Methyl C15 alkane | 12-methyl-15-alkane | C16H34 |
| Hydrocarbon (mono-methyl) | 13-Methyl C15 alkane | 13-methyl-15-alkane | C16H34 |
| Fatty acid (saturated) | C16:0 saturated fatty | Palmitic acid | C16H32O2 |
| | acid | | |
| Fatty acid (branched, iso) | iso-C16:0 fatty acid | iso-C16 fatty acid | C16H32O2 |
| | (mixture) | | |
| Fatty acid (branched, anteiso) | anteiso-C16:0 fatty | anteiso-C16 fatty acid | C16H32O2 |
| | acid (mixture) | | |
| Fatty acid (mono-unsaturated) | C16:1 Δ9 | Palmitoleic acid | C16H30O2 |
| Fatty acid (mono-unsaturated) | C16:1 Δ9 | C16:1 (Δ9) | C16H30O2 |
| Fatty acid (mono-unsaturated) | C16:1 Δ11 | C16:1 (Δ11) | C16H30O2 |
| Fatty acid (di-unsaturated) | C16:2 Δ9, 12 | C16:2 (Δ9, 12) | C16H28O2 |
| Fatty acid (di-unsaturated) | C16:2 Δ11, 14 | C16:2 (Δ11, 14) | C16H28O2 |
| Fatty acid (alpha-hydroxy) | 2-Hydroxy C16 fatty | 2-hydroxy C16 FA | C16H32O3 |
| | acid | | |
| Fatty acid (omega-hydroxy) | ω-Hydroxy C16 fatty | omega-hydroxy C16 FA | C16H32O3 |
| | acid | | |
| Fatty acid (2-oxo) | 2-Oxo C16 fatty acid | 2-oxo C16 FA | C16H30O3 |
| Fatty acid (omega-oxo) | ω-Oxo C16 fatty acid | omega-oxo C16 FA | C16H30O3 |
| Hydrocarbon | n-alkane (n-17 alkane) | Heptadecane | C17H36 |
| Hydrocarbon (branched) | iso-C17 alkane | iso-alkane | C17H36 |
| | (mixture) | | |
| Hydrocarbon (branched) | anteiso-C17 alkane | anteiso-alkane | C17H36 |
| | (mixture) | | |
| Hydrocarbon (mono-methyl) | 2-Methyl C16 alkane | 2-methyl-16-alkane | C17H36 |
| Hydrocarbon (mono-methyl) | 3-Methyl C16 alkane | 3-methyl-16-alkane | C17H36 |
| Hydrocarbon (mono-methyl) | 4-Methyl C16 alkane | 4-methyl-16-alkane | C17H36 |
| Hydrocarbon (mono-methyl) | 5-Methyl C16 alkane | 5-methyl-16-alkane | C17H36 |
| Hydrocarbon (mono-methyl) | 6-Methyl C16 alkane | 6-methyl-16-alkane | C17H36 |
| Hydrocarbon (mono-methyl) | 7-Methyl C16 alkane | 7-methyl-16-alkane | C17H36 |
| Hydrocarbon (mono-methyl) | 8-Methyl C16 alkane | 8-methyl-16-alkane | C17H36 |
| Hydrocarbon (mono-methyl) | 9-Methyl C16 alkane | 9-methyl-16-alkane | C17H36 |
| Hydrocarbon (mono-methyl) | 10-Methyl C16 alkane | 10-methyl-16-alkane | C17H36 |
| Hydrocarbon (mono-methyl) | 11-Methyl C16 alkane | 11-methyl-16-alkane | C17H36 |
| Hydrocarbon (mono-methyl) | 12-Methyl C16 alkane | 12-methyl-16-alkane | C17H36 |
| Hydrocarbon (mono-methyl) | 13-Methyl C16 alkane | 13-methyl-16-alkane | C17H36 |
| Hydrocarbon (mono-methyl) | 14-Methyl C16 alkane | 14-methyl-16-alkane | C17H36 |
| Fatty acid (saturated) | C17:0 saturated fatty | Heptadecanoic acid | C17H34O2 |
| | acid | | |
| Fatty acid (branched, iso) | iso-C17:0 fatty acid | iso-C17 fatty acid | C17H34O2 |
| | (mixture) | | |
| Fatty acid (branched, anteiso) | anteiso-C17:0 fatty | anteiso-C17 fatty acid | C17H34O2 |
| | acid (mixture) | | |
| Fatty acid (mono-unsaturated) | C17:1 Δ9 | C17:1 (Δ9) | C17H32O2 |
| Fatty acid (mono-unsaturated) | C17:1 Δ11 | C17:1 (Δ11) | C17H32O2 |
| Fatty acid (di-unsaturated) | C17:2 Δ9, 12 | C17:2 (Δ9, 12) | C17H30O2 |
| Fatty acid (di-unsaturated) | C17:2 Δ11, 14 | C17:2 (Δ11, 14) | C17H30O2 |
| Fatty acid (alpha-hydroxy) | 2-Hydroxy C17 fatty | 2-hydroxy C17 FA | C17H34O3 |
| | acid | | |
| Fatty acid (omega-hydroxy) | ω-Hydroxy C17 fatty | omega-hydroxy C17 FA | C17H34O3 |
| | acid | | |
| Fatty acid (2-oxo) | 2-Oxo C17 fatty acid | 2-oxo C17 FA | C17H32O3 |
| Fatty acid (omega-oxo) | ω-Oxo C17 fatty acid | omega-oxo C17 FA | C17H32O3 |
| Hydrocarbon | n-alkane (n-18 alkane) | Octadecane | C18H38 |
| Hydrocarbon (branched) | iso-C18 alkane | iso-alkane | C18H38 |
| | (mixture) | | |
| Hydrocarbon (branched) | anteiso-C18 alkane | anteiso-alkane | C18H38 |
| | (mixture) | | |
| Hydrocarbon (mono-methyl) | 2-Methyl C17 alkane | 2-methyl-17-alkane | C18H38 |
| Hydrocarbon (mono-methyl) | 3-Methyl C17 alkane | 3-methyl-17-alkane | C18H38 |
| Hydrocarbon (mono-methyl) | 4-Methyl C17 alkane | 4-methyl-17-alkane | C18H38 |
| Hydrocarbon (mono-methyl) | 5-Methyl C17 alkane | 5-methyl-17-alkane | C18H38 |
| Hydrocarbon (mono-methyl) | 6-Methyl C17 alkane | 6-methyl-17-alkane | C18H38 |
| Hydrocarbon (mono-methyl) | 7-Methyl C17 alkane | 7-methyl-17-alkane | C18H38 |
| Hydrocarbon (mono-methyl) | 8-Methyl C17 alkane | 8-methyl-17-alkane | C18H38 |
| Hydrocarbon (mono-methyl) | 9-Methyl C17 alkane | 9-methyl-17-alkane | C18H38 |
| Hydrocarbon (mono-methyl) | 10-Methyl C17 alkane | 10-methyl-17-alkane | C18H38 |
| Hydrocarbon (mono-methyl) | 11-Methyl C17 alkane | 11-methyl-17-alkane | C18H38 |
| Hydrocarbon (mono-methyl) | 12-Methyl C17 alkane | 12-methyl-17-alkane | C18H38 |
| Hydrocarbon (mono-methyl) | 13-Methyl C17 alkane | 13-methyl-17-alkane | C18H38 |
| Hydrocarbon (mono-methyl) | 14-Methyl C17 alkane | 14-methyl-17-alkane | C18H38 |
| Hydrocarbon (mono-methyl) | 15-Methyl C17 alkane | 15-methyl-17-alkane | C18H38 |
| Fatty acid (saturated) | C18:0 saturated fatty | Stearic acid | C18H36O2 |
| | acid | | |
| Fatty acid (branched, iso) | iso-C18:0 fatty acid | iso-C18 fatty acid | C18H36O2 |
| | (mixture) | | |
| Fatty acid (branched, anteiso) | anteiso-C18:0 fatty | anteiso-C18 fatty acid | C18H36O2 |
| | acid (mixture) | | |
| Fatty acid (mono-unsaturated) | C18:1 Δ9 | Oleic acid | C18H34O2 |
| Fatty acid (mono-unsaturated) | C18:1 Δ9 | C18:1 (Δ9) | C18H34O2 |
| Fatty acid (mono-unsaturated) | C18:1 Δ11 | C18:1 (Δ11) | C18H34O2 |
| Fatty acid (di-unsaturated) | C18:2 Δ9, 12 | Linoleic acid | C18H32O2 |
| Fatty acid (di-unsaturated) | C18:2 Δ11, 14 | C18:2 (Δ11, 14) | C18H32O2 |
| Fatty acid (polyunsaturated) | C18:3 Δ9, 12, 15 | α-Linolenic acid (ALA) | C18H30O2 |
| Fatty acid (polyunsaturated) | C18:3 Δ6, 9, 12 | γ-Linolenic acid (GLA) | C18H30O2 |
| Fatty acid (alpha-hydroxy) | 2-Hydroxy C18 fatty | 2-hydroxy C18 FA | C18H36O3 |
| | acid | | |
| Fatty acid (omega-hydroxy) | ω-Hydroxy C18 fatty | omega-hydroxy C18 FA | C18H36O3 |
| | acid | | |
| Fatty acid (2-oxo) | 2-Oxo C18 fatty acid | 2-oxo C18 FA | C18H34O3 |
| Fatty acid (omega-oxo) | ω-Oxo C18 fatty acid | omega-oxo C18 FA | C18H34O3 |
| Hydrocarbon | n-alkane (n-19 alkane) | Nonadecane | C19H40 |
| Hydrocarbon (branched) | iso-C19 alkane | iso-alkane | C19H40 |
| | (mixture) | | |
| Hydrocarbon (branched) | anteiso-C19 alkane | anteiso-alkane | C19H40 |
| | (mixture) | | |
| Hydrocarbon (mono-methyl) | 2-Methyl C18 alkane | 2-methyl-18-alkane | C19H40 |
| Hydrocarbon (mono-methyl) | 3-Methyl C18 alkane | 3-methyl-18-alkane | C19H40 |
| Hydrocarbon (mono-methyl) | 4-Methyl C18 alkane | 4-methyl-18-alkane | C19H40 |
| Hydrocarbon (mono-methyl) | 5-Methyl C18 alkane | 5-methyl-18-alkane | C19H40 |
| Hydrocarbon (mono-methyl) | 6-Methyl C18 alkane | 6-methyl-18-alkane | C19H40 |
| Hydrocarbon (mono-methyl) | 7-Methyl C18 alkane | 7-methyl-18-alkane | C19H40 |
| Hydrocarbon (mono-methyl) | 8-Methyl C18 alkane | 8-methyl-18-alkane | C19H40 |
| Hydrocarbon (mono-methyl) | 9-Methyl C18 alkane | 9-methyl-18-alkane | C19H40 |
| Hydrocarbon (mono-methyl) | 10-Methyl C18 alkane | 10-methyl-18-alkane | C19H40 |
| Hydrocarbon (mono-methyl) | 11-Methyl C18 alkane | 11-methyl-18-alkane | C19H40 |
| Hydrocarbon (mono-methyl) | 12-Methyl C18 alkane | 12-methyl-18-alkane | C19H40 |
| Hydrocarbon (mono-methyl) | 13-Methyl C18 alkane | 13-methyl-18-alkane | C19H40 |
| Hydrocarbon (mono-methyl) | 14-Methyl C18 alkane | 14-methyl-18-alkane | C19H40 |
| Hydrocarbon (mono-methyl) | 15-Methyl C18 alkane | 15-methyl-18-alkane | C19H40 |
| Hydrocarbon (mono-methyl) | 16-Methyl C18 alkane | 16-methyl-18-alkane | C19H40 |
| Fatty acid (saturated) | C19:0 saturated fatty | Nonadecanoic acid | C19H38O2 |
| | acid | | |
| Fatty acid (branched, iso) | iso-C19:0 fatty acid | iso-C19 fatty acid | C19H38O2 |
| | (mixture) | | |
| Fatty acid (branched, anteiso) | anteiso-C19:0 fatty | anteiso-C19 fatty acid | C19H38O2 |
| | acid (mixture) | | |
| Fatty acid (mono-unsaturated) | C19:1 Δ9 | C19:1 (Δ9) | C19H36O2 |
| Fatty acid (mono-unsaturated) | C19:1 Δ11 | C19:1 (Δ11) | C19H36O2 |
| Fatty acid (di-unsaturated) | C19:2 Δ9, 12 | C19:2 (Δ9, 12) | C19H34O2 |
| Fatty acid (di-unsaturated) | C19:2 Δ11, 14 | C19:2 (Δ11, 14) | C19H34O2 |
| Fatty acid (alpha-hydroxy) | 2-Hydroxy C19 fatty | 2-hydroxy C19 FA | C19H38O3 |
| | acid | | |
| Fatty acid (omega-hydroxy) | ω-Hydroxy C19 fatty | omega-hydroxy C19 FA | C19H38O3 |
| | acid | | |
| Fatty acid (2-oxo) | 2-Oxo C19 fatty acid | 2-oxo C19 FA | C19H36O3 |
| Fatty acid (omega-oxo) | ω-Oxo C19 fatty acid | omega-oxo C19 FA | C19H36O3 |
| Hydrocarbon | n-alkane (n-20 alkane) | Eicosane | C20H42 |
| Hydrocarbon (branched) | iso-C20 alkane | iso-alkane | C20H42 |
| | (mixture) | | |
| Hydrocarbon (branched) | anteiso-C20 alkane | anteiso-alkane | C20H42 |
| | (mixture) | | |
| Hydrocarbon (mono-methyl) | 2-Methyl C19 alkane | 2-methyl-19-alkane | C20H42 |
| Hydrocarbon (mono-methyl) | 3-Methyl C19 alkane | 3-methyl-19-alkane | C20H42 |
| Hydrocarbon (mono-methyl) | 4-Methyl C19 alkane | 4-methyl-19-alkane | C20H42 |
| Hydrocarbon (mono-methyl) | 5-Methyl C19 alkane | 5-methyl-19-alkane | C20H42 |
| Hydrocarbon (mono-methyl) | 6-Methyl C19 alkane | 6-methyl-19-alkane | C20H42 |
| Hydrocarbon (mono-methyl) | 7-Methyl C19 alkane | 7-methyl-19-alkane | C20H42 |
| Hydrocarbon (mono-methyl) | 8-Methyl C19 alkane | 8-methyl-19-alkane | C20H42 |
| Hydrocarbon (mono-methyl) | 9-Methyl C19 alkane | 9-methyl-19-alkane | C20H42 |
| Hydrocarbon (mono-methyl) | 10-Methyl C19 alkane | 10-methyl-19-alkane | C20H42 |
| Hydrocarbon (mono-methyl) | 11-Methyl C19 alkane | 11-methyl-19-alkane | C20H42 |
| Hydrocarbon (mono-methyl) | 12-Methyl C19 alkane | 12-methyl-19-alkane | C20H42 |
| Hydrocarbon (mono-methyl) | 13-Methyl C19 alkane | 13-methyl-19-alkane | C20H42 |
| Hydrocarbon (mono-methyl) | 14-Methyl C19 alkane | 14-methyl-19-alkane | C20H42 |
| Hydrocarbon (mono-methyl) | 15-Methyl C19 alkane | 15-methyl-19-alkane | C20H42 |
| Hydrocarbon (mono-methyl) | 16-Methyl C19 alkane | 16-methyl-19-alkane | C20H42 |
| Hydrocarbon (mono-methyl) | 17-Methyl C19 alkane | 17-methyl-19-alkane | C20H42 |
| Fatty acid (saturated) | C20:0 saturated fatty | Arachidic acid | C20H40O2 |
| | acid | | |
| Fatty acid (branched, iso) | iso-C20:0 fatty acid | iso-C20 fatty acid | C20H40O2 |
| | (mixture) | | |
| Fatty acid (branched, anteiso) | anteiso-C20:0 fatty | anteiso-C20 fatty acid | C20H40O2 |
| | acid (mixture) | | |
| Fatty acid (mono-unsaturated) | C20:1 Δ9 | C20:1 (Δ9) | C20H38O2 |
| Fatty acid (mono-unsaturated) | C20:1 Δ11 | C20:1 (Δ11) | C20H38O2 |
| Fatty acid (di-unsaturated) | C20:2 Δ9, 12 | C20:2 (Δ9, 12) | C20H36O2 |
| Fatty acid (di-unsaturated) | C20:2 Δ11, 14 | C20:2 (Δ11, 14) | C20H36O2 |
| Fatty acid (polyunsaturated) | C20:4 Δ5, 8, 11, 14 | Arachidonic acid (AA) | C20H32O2 |
| Fatty acid (polyunsaturated) | C20:5 Δ5, 8, 11, 14, 17 | Eicosapentaenoic acid | C20H30O2 |
| | | (EPA) | |
| Fatty acid (alpha-hydroxy) | 2-Hydroxy C20 fatty | 2-hydroxy C20 FA | C20H40O3 |
| | acid | | |
| Fatty acid (omega-hydroxy) | ω-Hydroxy C20 fatty | omega-hydroxy C20 FA | C20H40O3 |
| | acid | | |
| Fatty acid (2-oxo) | 2-Oxo C20 fatty acid | 2-oxo C20 FA | C20H38O3 |
| Fatty acid (omega-oxo) | ω-Oxo C20 fatty acid | omega-oxo C20 FA | C20H38O3 |
| Hydrocarbon | n-alkane (n-21 alkane) | Heneicosane | C21H44 |
| Hydrocarbon (branched) | iso-C21 alkane | iso-alkane | C21H44 |
| | (mixture) | | |
| Hydrocarbon (branched) | anteiso-C21 alkane | anteiso-alkane | C21H44 |
| | (mixture) | | |
| Hydrocarbon (mono-methyl) | 2-Methyl C20 alkane | 2-methyl-20-alkane | C21H44 |
| Hydrocarbon (mono-methyl) | 3-Methyl C20 alkane | 3-methyl-20-alkane | C21H44 |
| Hydrocarbon (mono-methyl) | 4-Methyl C20 alkane | 4-methyl-20-alkane | C21H44 |
| Hydrocarbon (mono-methyl) | 5-Methyl C20 alkane | 5-methyl-20-alkane | C21H44 |
| Hydrocarbon (mono-methyl) | 6-Methyl C20 alkane | 6-methyl-20-alkane | C21H44 |
| Hydrocarbon (mono-methyl) | 7-Methyl C20 alkane | 7-methyl-20-alkane | C21H44 |
| Hydrocarbon (mono-methyl) | 8-Methyl C20 alkane | 8-methyl-20-alkane | C21H44 |
| Hydrocarbon (mono-methyl) | 9-Methyl C20 alkane | 9-methyl-20-alkane | C21H44 |
| Hydrocarbon (mono-methyl) | 10-Methyl C20 alkane | 10-methyl-20-alkane | C21H44 |
| Hydrocarbon (mono-methyl) | 11-Methyl C20 alkane | 11-methyl-20-alkane | C21H44 |
| Hydrocarbon (mono-methyl) | 12-Methyl C20 alkane | 12-methyl-20-alkane | C21H44 |
| Hydrocarbon (mono-methyl) | 13-Methyl C20 alkane | 13-methyl-20-alkane | C21H44 |
| Hydrocarbon (mono-methyl) | 14-Methyl C20 alkane | 14-methyl-20-alkane | C21H44 |
| Hydrocarbon (mono-methyl) | 15-Methyl C20 alkane | 15-methyl-20-alkane | C21H44 |
| Hydrocarbon (mono-methyl) | 16-Methyl C20 alkane | 16-methyl-20-alkane | C21H44 |
| Hydrocarbon (mono-methyl) | 17-Methyl C20 alkane | 17-methyl-20-alkane | C21H44 |
| Hydrocarbon (mono-methyl) | 18-Methyl C20 alkane | 18-methyl-20-alkane | C21H44 |
| Fatty acid (saturated) | C21:0 saturated fatty | Heneicosanoic acid | C21H42O2 |
| | acid | | |
| Fatty acid (branched, iso) | iso-C21:0 fatty acid | iso-C21 fatty acid | C21H42O2 |
| | (mixture) | | |
| Fatty acid (branched, anteiso) | anteiso-C21:0 fatty | anteiso-C21 fatty acid | C21H42O2 |
| | acid (mixture) | | |
| Fatty acid (mono-unsaturated) | C21:1 Δ9 | C21:1 (Δ9) | C21H40O2 |
| Fatty acid (mono-unsaturated) | C21:1 Δ11 | C21:1 (Δ11) | C21H40O2 |
| Fatty acid (di-unsaturated) | C21:2 Δ9, 12 | C21:2 (Δ9, 12) | C21H38O2 |
| Fatty acid (di-unsaturated) | C21:2 Δ11, 14 | C21:2 (Δ11, 14) | C21H38O2 |
| Fatty acid (alpha-hydroxy) | 2-Hydroxy C21 fatty | 2-hydroxy C21 FA | C21H42O3 |
| | acid | | |
| Fatty acid (omega-hydroxy) | ω-Hydroxy C21 fatty | omega-hydroxy C21 FA | C21H42O3 |
| | acid | | |
| Fatty acid (2-oxo) | 2-Oxo C21 fatty acid | 2-oxo C21 FA | C21H40O3 |
| Fatty acid (omega-oxo) | ω-Oxo C21 fatty acid | omega-oxo C21 FA | C21H40O3 |
| Hydrocarbon | n-alkane (n-22 alkane) | Docosane | C22H46 |
| Hydrocarbon (branched) | iso-C22 alkane | iso-alkane | C22H46 |
| | (mixture) | | |
| Hydrocarbon (branched) | anteiso-C22 alkane | anteiso-alkane | C22H46 |
| | (mixture) | | |
| Hydrocarbon (mono-methyl) | 2-Methyl C21 alkane | 2-methyl-21-alkane | C22H46 |
| Hydrocarbon (mono-methyl) | 3-Methyl C21 alkane | 3-methyl-21-alkane | C22H46 |
| Hydrocarbon (mono-methyl) | 4-Methyl C21 alkane | 4-methyl-21-alkane | C22H46 |
| Hydrocarbon (mono-methyl) | 5-Methyl C21 alkane | 5-methyl-21-alkane | C22H46 |
| Hydrocarbon (mono-methyl) | 6-Methyl C21 alkane | 6-methyl-21-alkane | C22H46 |
| Hydrocarbon (mono-methyl) | 7-Methyl C21 alkane | 7-methyl-21-alkane | C22H46 |
| Hydrocarbon (mono-methyl) | 8-Methyl C21 alkane | 8-methyl-21-alkane | C22H46 |
| Hydrocarbon (mono-methyl) | 9-Methyl C21 alkane | 9-methyl-21-alkane | C22H46 |
| Hydrocarbon (mono-methyl) | 10-Methyl C21 alkane | 10-methyl-21-alkane | C22H46 |
| Hydrocarbon (mono-methyl) | 11-Methyl C21 alkane | 11-methyl-21-alkane | C22H46 |
| Hydrocarbon (mono-methyl) | 12-Methyl C21 alkane | 12-methyl-21-alkane | C22H46 |
| Hydrocarbon (mono-methyl) | 13-Methyl C21 alkane | 13-methyl-21-alkane | C22H46 |
| Hydrocarbon (mono-methyl) | 14-Methyl C21 alkane | 14-methyl-21-alkane | C22H46 |
| Hydrocarbon (mono-methyl) | 15-Methyl C21 alkane | 15-methyl-21-alkane | C22H46 |
| Hydrocarbon (mono-methyl) | 16-Methyl C21 alkane | 16-methyl-21-alkane | C22H46 |
| Hydrocarbon (mono-methyl) | 17-Methyl C21 alkane | 17-methyl-21-alkane | C22H46 |
| Hydrocarbon (mono-methyl) | 18-Methyl C21 alkane | 18-methyl-21-alkane | C22H46 |
| Hydrocarbon (mono-methyl) | 19-Methyl C21 alkane | 19-methyl-21-alkane | C22H46 |
| Fatty acid (saturated) | C22:0 saturated fatty | Behenic acid | C22H44O2 |
| | acid | | |
| Fatty acid (branched, iso) | iso-C22:0 fatty acid | iso-C22 fatty acid | C22H44O2 |
| | (mixture) | | |
| Fatty acid (branched, anteiso) | anteiso-C22:0 fatty | anteiso-C22 fatty acid | C22H44O2 |
| | acid (mixture) | | |
| Fatty acid (mono-unsaturated) | C22:1 Δ13 | Erucic acid | C22H42O2 |
| Fatty acid (mono-unsaturated) | C22:1 Δ9 | C22:1 (Δ9) | C22H42O2 |
| Fatty acid (mono-unsaturated) | C22:1 Δ11 | C22:1 (Δ11) | C22H42O2 |
| Fatty acid (di-unsaturated) | C22:2 Δ9, 12 | C22:2 (Δ9, 12) | C22H40O2 |
| Fatty acid (di-unsaturated) | C22:2 Δ11, 14 | C22:2 (Δ11, 14) | C22H40O2 |
| Fatty acid (polyunsaturated) | C22:6 | Docosahexaenoic acid | C22H32O2 |
| | Δ4, 7, 10, 13, 16, 19 | (DHA) | |
| Fatty acid (polyunsaturated) | C22:1 Δ13 | Erucic acid | C22H42O2 |
| Fatty acid (alpha-hydroxy) | 2-Hydroxy C22 fatty | 2-hydroxy C22 FA | C22H44O3 |
| | acid | | |
| Fatty acid (omega-hydroxy) | ω-Hydroxy C22 fatty | omega-hydroxy C22 FA | C22H44O3 |
| | acid | | |
| Fatty acid (2-oxo) | 2-Oxo C22 fatty acid | 2-oxo C22 FA | C22H42O3 |
| Fatty acid (omega-oxo) | ω-Oxo C22 fatty acid | omega-oxo C22 FA | C22H42O3 |
| Fatty acid (hydroxy, mono- | C18:1 Δ9, 12-hydroxy | Ricinoleic acid | C18H34O3 |
| unsaturated) | | | |

According to one aspect, the cationic group may be selected from the species listed in Table 3 below.

TABLE 3

| Name | Formula | Notes |
|---|---|---|
| Trimethylammonium | C3H10N+ | —N+(CH3)3 |
| Dimethylalkylammonium | RCH3)2N+ | —N+(CH3)2R |
| (generic) | | |
| Trialkylammonium (generic) | R3N+ | —N+R3 |
| Benzyltrimethylammonium | C10H16N+ | BTMA |
| Pyridinium | C5H6N+ | quaternized nitrogen in pyridine |
| | | ring |
| Imidazolium | C3H5N2+ | quaternized imidazole |
| Piperidinium (quaternary) | C5H12N+ | quaternized piperidine |
| Morpholinium (quaternary) | C4H10NO+ | quaternized morpholine |
| Quinuclidinium | C7H14N+ | |
| Pyrrolidinium (quaternary) | C4H10N+ | |
| Guanidinium | CH6N3+ | —C(═NH2+)NH2 |
| Amidinium (generic) | RC(═NH2+)NH— | |
| Primary ammonium | RNH3+ | protonated primary amine |
| Secondary ammonium | R2NH2+ | protonated secondary amine |
| Tertiary ammonium | R3NH+ | protonated tertiary amine |
| Phosphonium (quaternary) | R4P+ | quaternary phosphonium |
| Sulfonium (trialkyl) | R3S+ | trialkylsulfonium |

According to one aspect, the zwitterionic group may be selected from the species listed in Table 4 below.

TABLE 4

| Name | Formula | Notes |
|---|---|---|
| Betaine | C5H11NO2 | (CH3)3N+—CH2—COO— |
| Carboxybetaine (generic) | R—N+(CH3)2—(CH2)n-COO— | generic spacer betaine |
| Sulfobetaine (generic) | R—N+(CH3)2—(CH2)n-SO3— | |
| Phosphobetaine (generic) | R—N+(CH3)2—(CH2)n-PO3— | |
| Phosphocholine headgroup | C5H15NO4P | +N(CH3)3—CH2—CH2—O—PO3— |
| | (zwitterion) | |
| Amino acid (glycine) | C2H5NO2 | H3N+—CH2—COO— |
| zwitterion | | |
| Amino acid (alanine) | C3H7NO2 | H3N+—CH(CH3)—COO— |
| zwitterion | | |
| Amino acid (serine) | C3H7NO3 | OH-bearing |
| zwitterion | | |
| Amino acid (lysine) | C6H14N2O2 | net neutral at isolectric pH |
| zwitterion | | |

According to one aspect, the negatively charged counter ion may be selected from the species listed in Table 5 below.

TABLE 5

| Name | Formula | Notes |
|---|---|---|
| Chloride | Cl— | |
| Bromide | Br— | |
| Iodide | I— | |
| Fluoride | F— | less common with organocations |
| Thiocyanate | SCN— | pseudohalide |
| Cyanate | OCN— | |
| Nitrate | NO3— | |
| Nitrite | NO2— | |
| Perchlorate | ClO4— | regulated in some contexts |
| Chlorate | ClO3— | |
| Sulfate | SO4\hat{ }2— | |
| Bisulfate | HSO4— | |
| Carbonate | CO3\hat{ }2— | |
| Bicarbonate | HCO3— | |
| Phosphate | PO4\hat{ }3— | |
| Hydrogen phosphate | HPO4\hat{ }2— | |
| Dihydrogen phosphate | H2PO4— | |
| Borate | BO3\hat{ }3— | |
| Tetrafluoroborate | BF4— | common non-coordinating anion |
| Hexafluorophosphate | PF6— | common non-coordinating anion |
| Formate | CHO2— | HCOO— |
| Acetate | C2H3O2— | CH3COO— |
| Propionate | C3H5O2— | |
| Butyrate | C4H7O2— | |
| Lactate | C3H5O3— | |
| Citrate | C6H5O7\hat{ }3— | |
| Oxalate | C2O4\hat{ }2— | |
| Malonate | C3H3O4\hat{ }2— | |
| Succinate | C4H4O4\hat{ }2— | |
| Maleate | C4H2O4\hat{ }2— | cis-butenedioate |
| Fumarate | C4H2O4\hat{ }2— | trans-butenedioate |
| Benzoate | C7H5O2— | |
| Mesylate | CH3SO3— | methanesulfonate |
| Tosylate | C7H7SO3— | p-toluenesulfonate |
| Brosylate | C7H7BrO3S— | p-bromobenzenesulfonate |
| Triflate | CF3SO3— | trifluoromethanesulfonate |
| Nonaflate | C4F9SO3— | nonafluorobutanesulfonate |
| Camphorsulfonate | C10H15O3S— | (−)-CSA/+CSA mixtures |
| Methosulfate (methyl sulfate) | CH3OSO3— | counterion commonly used for quats |
| Ethyl sulfate | C2H5OSO3— | |
| Dodecyl sulfate | C12H25OSO3— | SDS anion; sometimes used in pairs |

Accordingly, surfactants according to the present disclosure may include a carbon tail derived from a compound listed in Table 2, a cationic group from Table 3 or a zwitterionic group from Table 4, and a negatively charged counter ion from Table 5. One of skill will readily understand that such species may be directly connected or may be connected by a linker group, such as an alkyl linker group of 2 to 6 carbon atoms. A preferred linker group is a three-carbon chain such as propyl.

### Example IV

### Materials and Methods

Perfluorooctanoic acid (H-PFOA), perlfluoroctanesulfonic acid potassium salt (K-PFOS), perfluorobutanoic acid (H-PFBA), and perflurobutanesulfonic acid (K-PFBS) were all purchased from Sigma Aldrich (St. Louis, MO). Groundwater impacted by aqueous film-forming foam (AFFF) was collected from a military installation located in the eastern United States. The known properties of this groundwater are presented in Section SI of the Supplementary information (SI). Cetyltrimethylammonium bromide (CTAB) and cetyltrimethylammonium chloride (CTAC) were purchased from Sigma Aldrich (St. Louis, MO). Shea butteramidopropyl betaine (SBAB) was purchased from Simply Ingredients (Santa Monica, CA) and Shea butteramidopryltrimonium chloride (SBATC) was obtained from Kimika LLC (Doral, FL). Behentrimonium chloride (BHC) was purchased form Ninth Avenue (Harrow, United Kingdom). Synthetic groundwater (SGW) was prepared with MgSO₄, NaHCO₃, KCl, and CaCl₂ (ionic strength=8.5 mM) with all salts purchased from Fisher Scientific (Waltham, MA). All solutions were prepared with ultrapure MilliQ water (18MΩ-cm). LC-MS grade methanol (MeOH) was purchased from Honeywell (Charlotte, NC) and glacial acetic acid was purchased from Fisher Chemical (Fair Lawn, NJ). All PFAS internal standard and calibration standard stock solutions were purchased from Wellington Laboratories (Guelph, ON, Canada). Mobile phases for liquid-chromatography mass spectrometry (LC-MS) were identified and used.

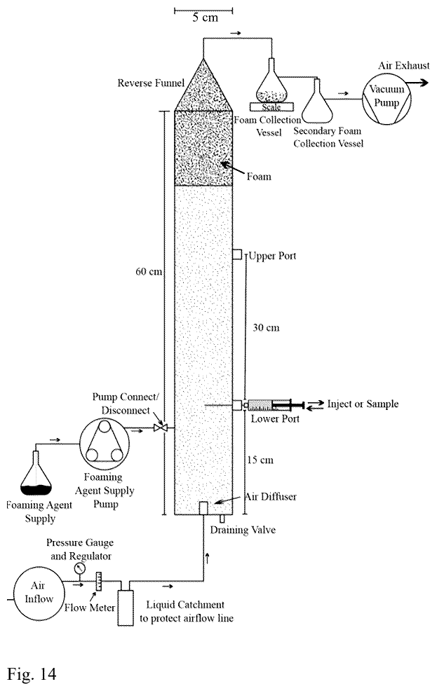

Foam Fractionation Apparatus: The laboratory-scale foam fractionation system used in this example is shown in schematic in FIG. 14. The main body of the system consists of a hollow acrylic cylinder, 60 cm in height by 5 cm diameter (ePlastics, Coppell, TX). Along the body of the column an adhesive measuring tape was applied to assist in monitoring water and foam volumes. Threaded ports for sampling or injecting are located 15 cm and 30 cm from the bottom of the column. The external portion of these ports consists of a Luer-lock connection that allows for replacement septa (QOSINA, Ronkankoma, NY). Between the lower sampling port and bottom of the column an additional port is equipped with a Hamilton valve (Hamilton Company, Reno, NV) connected to a Masterflex L/S® peristaltic pump (VWR, Radnor, PA) used to deliver co-surfactants into the system. A custom fabricated stainless-steel endplate, consisting of a drainage valve and an inline air-stone with 0.5 μm pores, is threaded to the bottom of the column. The air-stone has a barb connection to ¼″ diameter flexible vacuum tubing for the delivery of laboratory compressed air into the system. Compressed air flows through a pressure gauge (NOSHOK, Berea, OH) tuned with a pressure regulator (IMI Norgren, Birmingham, UK), an air-flow meter (King Instrument Company, Garden Grove, CA) and a trap installed in the case of liquid escaping through the pores of the air-stone. At the top of the column an inverted funnel is connected to the flexible tubing to allow foam to flow into a vacuum flask. The vacuum flask is placed on a scale (Mettler Toledo, Columbus OH) to monitor foam collection. This flask is connected to a secondary (safety) vacuum flask before being connected to a vacuum pump (Welch, Ilmenau, Germany) equipped with a vacuum gauge (Ashcroft, Stratford, CT). All flexible tubing connections were secured with hose clamps.

Surface Tension Measurements: Aqueous solutions were prepared in synthetic groundwater with addition of the desired co-surfactant in 125 mL HDPE bottles which were used as the container for measurement. Surface tension measurements were made with a Sigma 700 precision force tensiometer (Biolin Scientific, Gothenburg Sweden) equipped with a micro-roughened platinum Wilhelmy plate (Nanoscience Instruments, Phoenix, AZ). Prior to each measurement the plate was removed from the microbalance, rinsed with MilliQ water and methanol and heated with a butane torch until flamed red in color to remove traces from the previous run. All surface tension data were obtained in sets of five measurements per solution at room temperature (21.5±1 °C).

Foam Fractionation System Operation: Operation of the foam fractionation system is as previously described herein. After each experiment, the system was cleaned by thorough rinsing with water and methanol and then air drying. Septa and sampling needles were replaced for each experiment. Field groundwater samples were centrifuged at 4000 rpm for 30 minutes in an Eppendorf 5804 benchtop centrifuge (Eppendorf, Hamberg, Germany) prior to use to remove particulates that may clog air-stone pores. To obtain initial PFAS concentrations, the solutions were sampled prior to being added to the foam fractionation system.

At the start of an experiment, the contaminated solution (synthetic or field groundwater) was poured into the column up to the 55 cm mark. The inverted funnel was quickly secured to the system, and the air, vacuum, and co-surfactant feed pump were simultaneously turned on at an air-flow rate of 1 standard cubic foot per hour (SCFH). The baseline dosing rate was 1 mg co-surfactant/min, while other dosing rates are explored for optimization purposes. Aqueous samples were taken in triplicate from the lower and upper sampling ports at selected timepoints (2 min, 5 min, 10 min, 15 min, 20 min, 25 min, 30 min, 40 min, 50 min, 60 min, 75 min, 90 min, 105 min, 120 min) for up to a 2-hr run time, and the system was continuously monitored to ensure consistency in air and vacuum pressures as well as for changes in water and foam heights and the volume of foam collected. The dosing and sampling procedures maintained the water height nearly constant, and any dilution was negligible relative to the total volume of the reactor system. The foam fractionation experiments were conducted at room temperature, using experimental conditions and initial PFAS concentrations. Samples were prepared for quantification by adding a 1 mL sample to an LC-MS vial with addition of internal standard at 10% volume. At the end of each experiment, the foam was allowed to coalesce, and the volume was tracked. The foamate was then diluted and similarly prepared for PFAS quantification.

PFAS Analysis: The analytical methods used to measure PFAS are as described previously herein. Briefly, samples were analyzed using a Waters AQUITY H-Class ultra-performance liquid chromatography system (UPLC) equipped with XEVO TQ-S Micro triple quadrupole mass spectrometer (TQS). Samples collected from experiments conducted with field groundwater were prepared and analyzed following the protocols described in EPA Method 1633.35 For all other experiments, samples and standards were prepared with addition of internal standard solution to the sample 10% (v/v) in MeOH with 1% (v/v) glacial acetic acid.

### Example V

Foam Fractionation of PFAS with Shea Butteramidopropyltrimonium Chloride

As previously described herein, shea butteramidopropyl betaine referred to in shorthand as “SBAB”, “NDZS” or “SBDS” was identified as a low-toxicity surfactant for removal of PFAS using foam fractionation. However, as a zwitterionic surfactant, the pH was reduced to 3 to achieve effective removal of short-chain PFAS. As described herein, SBAB had a longer run time compared to CTAB (i.e., 4 hours vs 2 hours for CTAB) to achieve the near complete removal of short-chain PFAS obtained in synthetic groundwater containing ~120 μg total PFAS/L. The longer run time for SBAB resulted in a greater foam volume, which reduced the volume reduction factor and PFAS enrichment factor.

According to one aspect, shea butteramidopropyltrimonium chloride (SBATC), was identified and tested as a surfactant using a synthetic groundwater solution containing two long-chain PFAS (PFOA, PFOS) and two short-chain PFAS (PFBA, PFBS). The SBATC co-surfactant was introduced at a mass flow rate of 1.0 mg/min. As shown in FIG. 15, addition of SBATC resulted in rapid removal of both long and short-chain PFAS from synthetic groundwater into the foam.

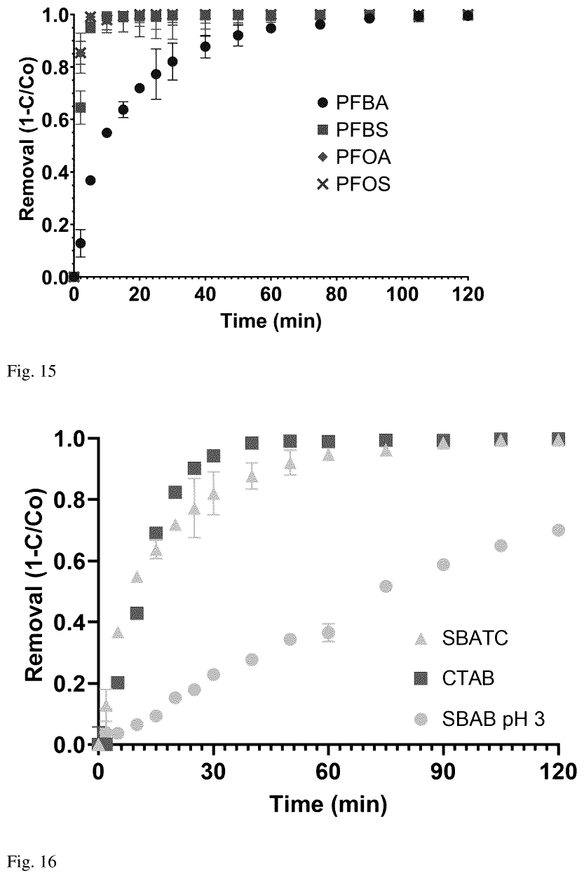

With the same dosing rate of 1.0 mg/min and an identical background matrix with similar initial PFAS concentrations, CTAB and SBAB also rapidly removed PFOA, PFOS, and PFBS in a similar manner to SBATC. However, SBAB did not remove PFBA as rapidly as CTAB or SBATC even when the pH was adjusted 3 to achieve a greater net cationic charge (FIG. 16). PFBA achieved >90% removal from the water after 60 min with CTAB and SBATC, while the SBAB exhibited more gradual removal of PFBA.

The removal percentage quantifies how much the PFAS of interest remains in the bulk water and is expressed as the fraction of a compound relative to the initial concentration that is no longer detected in the aqueous phase (Equation 4). A second metric, enrichment, is the ratio of PFAS in the foam to the PFAS concentration in the bulk liquid (Equation 5), where a high enrichment would indicate that all the removed PFAS is recovered and concentrated in a small volume of collapsed foamate, where the ratio of collapsed foamate liquid to the initial solution volume is defined as the volume reduction factor (VRF) (Equation 6). Since foam is a gas/liquid dispersion, the composition of foam in an ideal foam fractionation system would have a low liquid content in order to achieve high enrichment of PFAS. To further concentrate foam with a high liquid content into a smaller volume, multistage treatment (i.e., secondary and tertiary foam fractionation) may be carried out. While SBATC exhibited similar removal behavior for PFBA compared to CTAB, the enrichment was greater using SBATC. The recoveries of PFBA for both surfactants were approximately 80%, yet the volume of foam generated with the SBATC was approximately one-third less than that generated with CTAB, leading to triple the VRF.

$$Removal \% = 1 - ( \frac{{C}_{tf}^{aq}}{{C}_{initial}^{aq}} ) \qquad ( 4 )$$

$$Enrichment = \frac{{C}_{tf}^{foam}}{{C}_{initial}^{aq}} \qquad ( 5 )$$

$$VRF = \frac{{V}_{aqeuous , initial}}{{V}_{foam , liq , final}} \qquad ( 6 )$$

Foaming behavior is strongly influenced by the composition of the surfactant at the air-water interface. Various properties of the surfactant responsible for the formation of the foam dictate the foam properties, including foam persistence and stability. See Key properties include surfactant size, chain length, and charge, as well as interfacial properties such as adsorption rates and critical micelle concentration. According to the present disclosure, these properties may be evaluated to select a particular surfactants utilized for foam fractionation.

### Example VI

### Surface Tension

The surface tension data for CTAB, SBATC, and BHC (see FIG. 17) shows that at the lowest concentrations, BHC exhibited the greatest reduction in surface tension. The concentration at which the surface tension reached an asymptote was ~5 mg/L BHC, compared to ~50 mg/L for SBATC and ~250 mg/L for CTAB. The inflection in the surface tension curves typically corresponds to either the critical micelle concentration (CMC) or aqueous solubility of the surfactant. The surface tension trends are consistent with Traube's Rule, which states that the concentration of surfactant needed to obtain a desired surface tension reduction diminishes for each additional methylene group in dilute surfactant solutions.

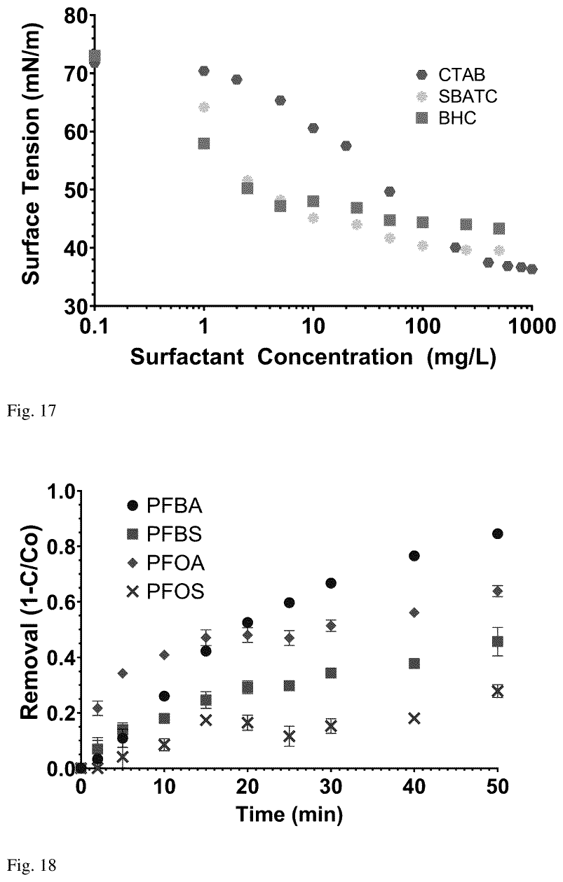

Although BHC exhibited substantial surface tension reduction at low concentrations (FIG. 17, the observed PFAS removal shown in FIG. 18 was considerably less than that obtained with SBATC (FIG. 15). Additionally, the PFAS removal trends were reversed, with PFBA exhibiting the greatest removal and PFOS exhibiting the lowest removal (FIG. 18). This behavior was attributed to the lower critical micelle concentration (CMC) of BHC (~10 mg/L), and the corresponding formation of mixed micelles containing BCH and PFOS due to its greater hydrophobicity, which would reduce the amount of free PFOS available for adsorption at the air-water interface. In contrast, due to its lower hydrophobicity, PFBA is less likely to the aggregate with the BHC allowing for removal through ion-pairing with BHC monomers and co-adsorption on air-water interface.

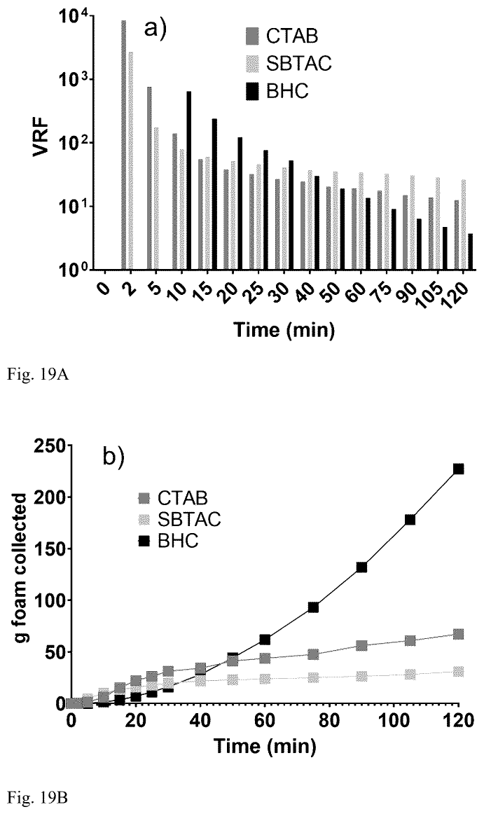

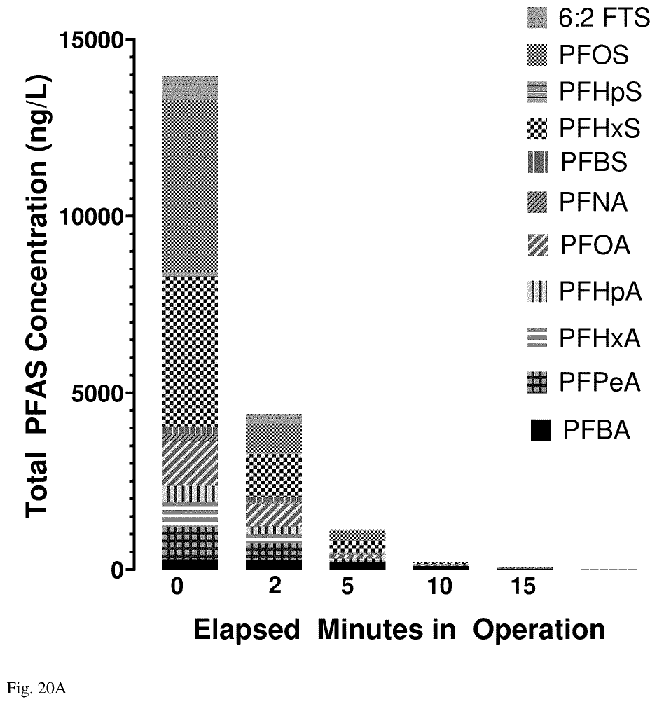

SBATC is a more favorable co-surfactant than CTAB or BHC for foam fractionation based on the VRF (see FIG. 19A) and the amount of foam collected, expressed as the collapsed liquid (see FIG. 19B), over the course of each experiment. The greater VRFs obtained for SBATC indicate that less foam is created (FIG. 19A), which is desirable because a smaller volume of contaminated liquid will be generated by the foam fractionation process. In general, surfactants with lower CMCs exhibit better foaming behavior, however, plots comparing surfactant chain length to favorable foaming behavior typically exhibit an inverted U-shape, with shorter chain length surfactants exhibiting inferior packing on the air bubble surface and longer chain length surfactant producing more rigid foams with low stability. This behavior is consistent with the foam generation curves shown in FIG. 6b, where the longer chain length of BHC resulted in foams with higher liquid content and lower stability over the course of the experiment. These findings indicate that chain length is an important consideration during selection of co-surfactants for foam fractionation systems, and that SBATC possesses a favorable chain length for PFAS removal under the experimental conditions tested here.

### Example VII

PFAS Removal with SBATC in AFFF Impacted Groundwater

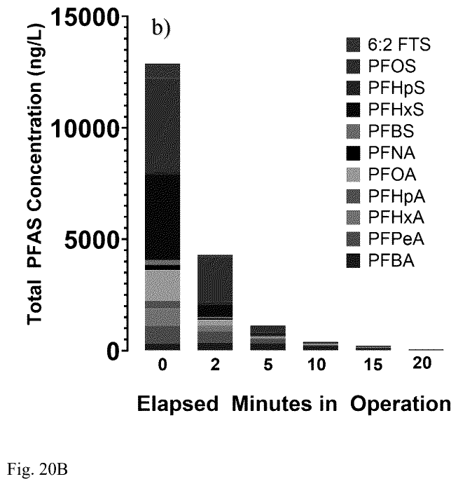

Since SBATC exhibited high removal of PFAS and stable foam formation with synthetic groundwater, further testing was performed using AFFF-impacted groundwater obtained from a military installation in the eastern United States. PFAS removal from the AFFF-impacted groundwater with CTAB and SBATC addition are shown in FIG. 20A-20B. After approximately 20 minutes of operation, PFAS were completely removed from the groundwater, with CTAB reaching non-detect levels (FIG. 20A) slightly faster than SBATC (FIG. 20B). Similar to the synthetic groundwater experiments, less foam was generated by SBATC compared to the CTAB despite nearly identical removal performance. Thus, while CTAB exhibited slightly faster total PFAS removal, the final VRF for CTAB was ~40% less than that of SBATC, indicating that SBATC yields better enrichment (Eq. 5) of PFAS in a smaller foam volume.

### Example VIII

### Effect of SBATC Dosing Rate on PFAS Removal

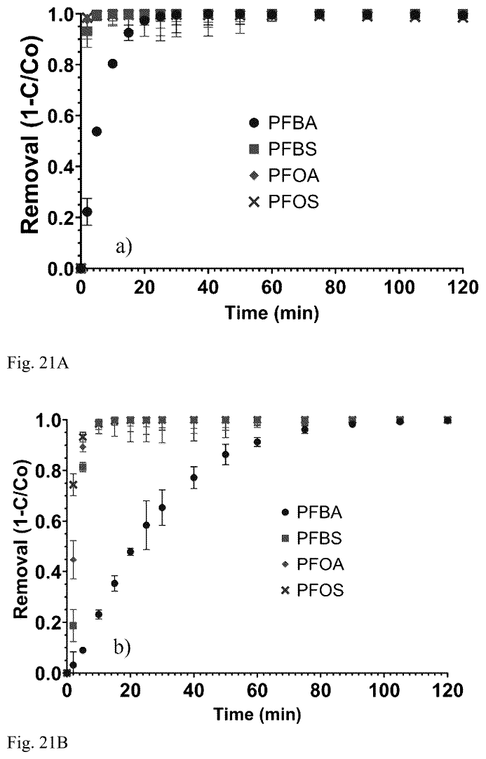

To reduce material usage and costs, the SBATC experiments were repeated with shallow ground water (SGW) containing four PFAS at lower SBATC dosing rates of 0.5 mg/min and 0.1 mg/min. At each dosing rate, rapid removal of the PFAS was observed, with faster removal of total PFAS obtained with the 0.5 mg/min rate (FIG. 21A) compared to the 1.0 mg/min rate (FIG. 15) and the 0.1 mg/min rate (FIG. 21B). The operation time required for total PFAS removal from the system was achieved after 90 min, 40 min, and 120 min for the 1.0 mg/min, 0.5 mg/min, and 0.1 mg/min dosing rates, respectively. Since SBATC consists of a mixture of cationic surfactants dominated by those derived from stearic and oleic acid, see Di Vincenzo, D. et al., Regional Variation in Shea Butter Lipid and Triterpene Composition in Four African Countries. J. Agric. Food Chem. 2005, 53 (19), 7473-7479, and oleic acid surfactants are more surface active than stearic acid surfactants, at the higher dosing rate (1.0 mg/min), it is likely that competition between the cationic species for surface sites on the air bubbles reduced PFAS removal efficiency. Here, the unpaired oleic compounds may dominate adsorption to the air-water interface, and in turn, reduce the removal of short-chain PFAS which relies upon ion pairing. At the lower dosing rate of 0.1 mg/min, it is likely that less cationic surfactant was available to interact with the short-chain PFAS. Therefore, the intermediate dosing rate of 0.5 mg/min allowed for rapid and stable foam formation without competition for adsorption sites, resulting in the fastest PFAS removal.

### Example IX

### Cytotoxicity Materials and Methods

Caco-2 human colon cells and zebrafish liver (ZFL) cells were purchased from American Type Culture Collection (ATCC) (Manassas, VA) as well as Eagle's minimum essential medium (EMEM) and Leibovitz L15 (L-15) medium. AlamarBlue™ (AB) cell viability reagent, 5-carboxyfluorescein diacetate acetoxymethyl ester (5-CFDA, AM), Dulbecco's Modified Eagle Medium (DMEM) powder, Ham's F-12 nutrient mix powder, and Dulbecco's phosphate buffered saline (DPBS; 1× without calcium and magnesium) were purchased from Thermo-Fisher Scientific (Fair Lawn, NJ). Rainbow trout serum was purchased from Phoenix Scientific (St. Joseph, MO). Fetal bovine serum (FBS), heat inactivated fetal bovine serum, and DPBS (1× with calcium and magnesium) was purchased from Corning Life Sciences (Tewksbury, MA). Human insulin, epidermal growth factor (EGF) from mouse, (4-(2-hydroxyethyl)-1-piperazineethanesulfonic acid) (HEPES), sodium bicarbonate, Triton X-100, and penicillin-streptomycin (P/S) were all purchased from Sigma Aldrich (St. Louis, MO). Count kit-8 (CCK-8) solution was purchased from APExBIO (Houston, TX, USA). The Cytoscan Lactate Dehydrogenase (LDH) Cytotoxicity kit was purchased from G Biosciences (St. Louis, Missouri). Ultrapure water (18.2 mΩ Milli-Q) from EMD Millipore (Taunton, MA) was used in all experiments.

Caco-2 cells were cultured in EMEM supplemented with 20% (v/v) FBS and 1% (v/v) P/S. Cells were cultured in 25 cm² cell culture flasks, passaged with 0.25% trypsin-EDTA and incubated at 37 °C with 5% CO₂. Cells were cultured to 80-90% confluency before plating for toxicity assays and used within passaged 9-13. ZFL cells were cultured in 50% (v/v) L-15, 35% (v/v) DMEM high glucose, 15% (v/v) Ham's F12, all without sodium bicarbonate, supplemented with 0.15 g/L sodium bicarbonate, 15 mM HEPES, 10 μg/mL human insulin, 50 ng/ml mouse EGF, 5% (v/v) heat-inactivated FBS, 0.5% (v/v) trout serum, and 1% (v/v) P/S. ZFLs were cultured at 28 °C in 75 cm² cell culture flasks, and sub-cultured every 4-5 days. Cells were used within passage numbers 8-11. For the latter, cells were briefly rinsed with 0.25% trypsin-EDTA, followed by the addition of 0.25% trypsin-EDTA for detachment. Trypsinization was stopped by the addition of ZFL complete media with 10% (v/v) FBS. Cells were collected by centrifugation and then split into new flasks or plated for toxicity assays.

Cytotoxicity assays were performed to assess potential toxicity of CTAB, CTAC, SBATC, and SBAB. Caco-2 cells were used as a proxy for human toxicity via water ingestion and ZFL cells were used as a proxy for aquatic toxicity. Each surfactant was tested for cytotoxicity over a range of 0-10 mg/L in solution. To assess potential human toxicity, Caco-2 cells were exposed to each surfactant and evaluated using complementary viability and cytotoxicity assays. Viability was quantified with the sensitive colorimetric CCK-8 assay (see Song, Y. et al., In Vitro Cytotoxicity of Silver Nanoparticles and Zinc Oxide Nanoparticles to Human Epithelial Colorectal Adenocarcinoma (Caco-2) Cells. Mutation Research/Fundamental and Molecular Mechanisms of Mutagenesis 2014, 769, 113-118) whereas cytotoxicity was determined by LDH release (see Ma, J. et al., Comparison of Anticancer Activity between Lactoferrin Nanoliposome and Lactoferrin in Caco-2 Cells in Vitro. Food and Chemical Toxicology 2013, 59, 72-77). Both methods are widely recognized for their reliability in cytotoxicity and chemical screening studies. A zebrafish cell line (ZFL) was employed for aquatic toxicity determination with methods consistent with the Organization for Economic Co-operation and Development (OECD) Guideline 249. See Rodrigues De Souza, I. et al., Cytotoxicity Assays with Zebrafish Cell Lines. JoVE 2023, No. 191, 64860. The AlamarBlue® and CFDA-AM assays are both fluorometric assays which have been found to perform well with ZFL cells. An additional advantage of choosing these assays for analysis is that they may be combined on the same set of cells, for high throughput screening of compounds of interest while working with ZFL cells.

Statistical analyses were performed in GraphPad Prism 10.6. All studies included at least three technical and biological replicates. Significance between groups was determined using one-way analysis of variance (ANOVA) with Tukey's multiple comparison test, α=0.05.

### Example X

### Cell Viability Studies (CCK-8 Assay)

For assessment of Caco-2 viability, cells were seeded at a density of 10,000 cells/well in a 96-well plate with 100 μL of EMEM containing 20% (v/v) FBS and 1% (v/v) P/S. Following a 24 h incubation of the cells at 37 °C with 5% CO₂, the medium was replaced with 100 μL of fresh low-serum medium containing the surfactants at the appropriate concentration. Untreated cells served as positive controls (PC), while wells containing media and no cells or treatment were used as negative controls (NC) of metabolic activity. After a 24 h incubation, media was removed, cells were gently washed once with 1×DPBS, and 100 μL of fresh low-serum media containing 10% (v/v) CCK-8 solution was added. Cells were incubated at 37 °C with 5% CO₂ for 2 h prior to reading the absorbance at 450 nm (Abs450) using a Cytation 3 plate reader (BioTek, Winooski, VT, USA). Normalized cell viability was determined using:

$$Normalized Cell Viability ( \% ) = \frac{Abs {450}_{sample} - Abs {450}_{NC}}{Abs {450}_{PC} - Abs {450}_{NC}} \times 100 \qquad ( 1 )$$

### Example XII

### Cell Cytotoxicity Studies (LDH Assay)

To determine Caco-2 cytotoxicity upon surfactant exposure, cells were seeded at a density of 10,000 cells/well in a 96-well plate with 100 μL of EMEM containing 20% (v/v) FBS and 1% (v/v) P/S. Following a 24 h incubation of the cells at 37 °C with 5% CO₂, the medium was replaced with 100 μL of fresh low-serum medium containing the surfactants at the appropriate concentration. Maximum LDH served as positive controls, while spontaneous LDH activity was used as a negative control of metabolic activity. After a 24 h incubation, 10 μL of lysis buffer [10×] was added to the maximum LDH activity control wells, mixed gently by tapping and incubated for 45 minutes at 37 °C with 5% CO₂. Then, 50 μL of the medium from each sample well was transferred into a new 96-well flat-bottom plate, in triplicates. 50 μL of the reaction mixture was added to each well, mixed and incubated at room temperature for 30 mins protected from light. After 30 mins, 50 μL of Stop Solution was added to each well and mixed gently by tapping. The absorbance of the plate was read at 490 nm and 680 nm using a Cytation 3 plate reader (BioTek, Winooski, VT, USA). The LDH activity was calculated by subtracting the 680 nm reading (background) from the 490 nm reading. % Cytotoxicity was determined using:

$$Cytoxocitiy ( \% ) = \frac{Compound Treated - Spontaneous LDH Activity}{Maximum LDH release - Spontaneous LDH Activity} \times 100 \qquad ( 2 )$$

### Example XIII

### Cell Viability Studies (Combined AlamarBlue® and CFDA-AM Assay)

To evaluate ZFL cell viability, cells were seeded at a density of 25,000 cells/well in a 96-well plate with 200 μL of ZFL complete growth media containing 5% (v/v) FBS, 0.5% (v/v) trout serum, and 1% (v/v) P/S. Following a 24 h incubation of the cells at 28 °C, the medium was replaced with 100 μL of fresh medium (without FBS and trout serum) containing the surfactants at the appropriate concentration. Untreated cells served as positive controls (PC), while wells containing media and no cells or treatment were used as negative controls (NC). To perform AB/CFDA-AM assay, a solution of 5% (v/v) AlamarBlue® and 4 μM CFDA-AM was made in 1×DPBS. After a 24 h incubation, media was removed, cells were gently washed once with 1×DPBS, and 100 μL of AB/CFDA-AM solution was added. Cells were incubated at 28 °C for 30 min in the dark prior to reading the fluorescence (Fluo) at 530 nm (excitation) and 595 nm (emission) for AB, and at 493 nm (excitation) and 541 nm (emission) for CFDA-AM using a Cytation 3 plate reader (BioTek, Winooski, VT, USA). Normalized cell viability was determined using:

$$Normalized Cell Viability ( \% ) = \frac{{Fluo}_{sample} - {Fluo}_{NC}}{{Fluo}_{PC} - {Fluo}_{NC}} \times 100 \qquad ( 3 )$$

### Example XIV

### Cytotoxicity Toxicity Results

Cosmetic products derived from shea have been designated as nontoxic by the expert panel of the Cosmetic Ingredient Review (CIR). See Burnett, C. L. et al., Safety Assessment of Butyrospermum parkii (Shea)-Derived Ingredients as Used in Cosmetics. Int J Toxicol 2024, 43 (1_suppl), 82S-95S. The present disclosure is directed to the use of naturally-derived surfactants for PFAS remediation and accordingly, evaluation of the safety of such bio-based surfactants is provided. Toxicity assays were conducted in both human and fish cell lines, enabling a direct comparison of human and aquatic toxicity to examine potential risks associated with the compounds in the event of accidental release or discharge to water. For these studies, Caco-2 human colon carcinoma cells were selected, which have been shown to take on enterocyte-like function and morphology in culture, serving as a model of human intestinal cells, along with ZFL cells, which is a well-established cell line used to predict acute toxicity in aquatic species.

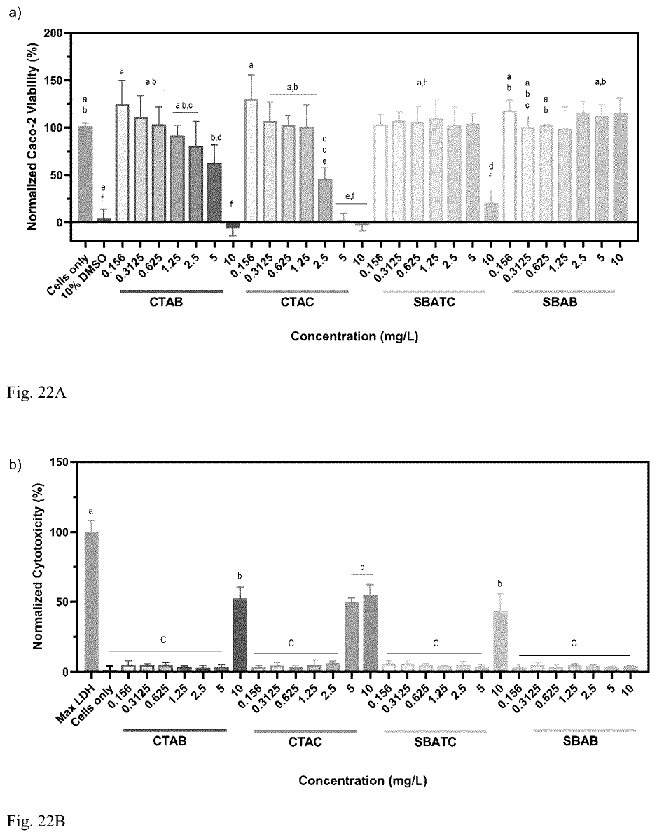

The viability of Caco-2 cells exposed to a range of CTAB, CTAC, SBATC, and SBAB concentrations was measured using a CCK-8 assay. As shown in FIG. 22A, the metabolic activity of Caco-2 cells was significantly reduced compared to untreated controls following exposure to the commonly used surfactants CTAB (10 mg/L) and CTAC (10 mg/L and 5 mg/L), both performing worse than the 10% DMSO control. Additionally, at a CTAC concentration of 2.5 mg/L, normalized viability was reduced to ~46%. The shea-derived SBATC also caused a reduction in viability (~21% normalized viability at 10 mg/L). At this concentration (10 mg/L), CTAC, CTAB, and SBATC exhibited no statistically significant differences, indicating comparable decrease in cell viability. In contrast, lower concentrations of SBATC did not diminish cell viability, and the zwitterionic shea butter-derived surfactant SBAB maintained full cell viability even at the highest concentration tested (10 mg/L).

To assess cell membrane integrity upon exposure to the surfactants, the release of the intracellular enzyme LDH from the Caco-2 cell line was measured after a 24-hour exposure to the surfactants. As shown in FIG. 22B, CTAC, CTAB, and SBATC induced a significant increase in cytotoxicity, reflected by elevated LDH release compared to untreated controls, exhibiting ~52%, ~55%, and ~43% cytotoxicity at 10 mg/L, respectively, where the maximum LDH control treatment was considered 100% cytotoxic. At 10 mg/L, no statistically significant differences were observed among CTAC, CTAB, and SBATC. The cationic surfactant CTAC also caused increased cytotoxicity (~50%) at 5 mg/L. Importantly, while cell viability was clearly compromised with exposure to CTAB and CTAC at concentrations as low as 2.5 mg/L, LDH release was not detected at these low surfactant concentrations comparable to the cells only group. Compared to exposure to CTAC, CTAB, and SBATC, SBAB exposure did not cause Caco-2 cytotoxicity even at 10 mg/L. Across lower concentration ranges, CTAB (0.156-5 mg/L), CTAC (0.156-2.5 mg/L), SBATC (0.156-5 mg/L), and SBAB (0.156-10 mg/L) exhibited no statistically significant differences in Caco-2 cytotoxicity.

The reduction in metabolic activity and the increase in cytotoxicity observed at higher concentrations of CTAB and CTAC have been previously reported. In particular, the cationic surfactant CTAB, which is widely used in the synthesis and stabilization of nanoparticles (e.g., gold particles), has been shown to impair cell membranes, induce apoptosis, and inhibit ATP synthase, ultimately leading to mitochondrial dysfunction in mammalian cells. See Timmer, N. et al., Toxicity Mitigation and Bioaccessibility of the Cationic Surfactant Cetyltrimethylammonium Bromide in a Sorbent-Modified Biodegradation Study. Chemosphere 2019, 222, 461-468. Similarly, an ~50% decrease in Caco-2 cell viability was reported with CTAB used in solid lipid nanoparticles at a concentration of 8.91 mg/L compared to untreated controls, consistent with our experimental results. See Silva, A. et al., Soft Cationic Nanoparticles for Drug Delivery: Production and Cytotoxicity of Solid Lipid Nanoparticles (SLNs). Applied Sciences 2019, 9 (20), 4438.

Overall, the shea butter-derived surfactants SBATC and SBAB exhibited lower toxicity toward the human-derived Caco-2 cells compared to the other surfactants tested. SBATC only exhibited toxicity at the highest concentration tested (10 mg/L), while at lower concentrations (0.156-5 mg/L), cell viability remained significantly higher than with other surfactants, including CTAC (2.5-10 mg/L) and CTAB (10 mg/L). Similarly, SBAB at 10 mg/L demonstrated significantly lower toxicity compared to SBATC (10 mg/L), CTAC (2.5-10 mg/L), and CTAB (10 mg/L). Although not identical to SBAB, other amphoteric surfactants such as coconut derived cocamidopropyl betaine (CAPB) are recognized as safe, low-toxicity ingredients in cosmetic and personal care products. See Kim, D. et al., Safety Assessment of Cocamidopropyl Betaine, a Cosmetic Ingredient. Toxicol Res. 2024, 40 (3), 361-375. While not wishing to be bound by scientific theory, the low toxicity of the zwitterionic surfactant SBAB may be due to its neutral charge, which, unlike cationic surfactants, leads to weaker interactions with the negatively charged mammalian cell membrane, thereby reducing the potential for membrane destabilization.

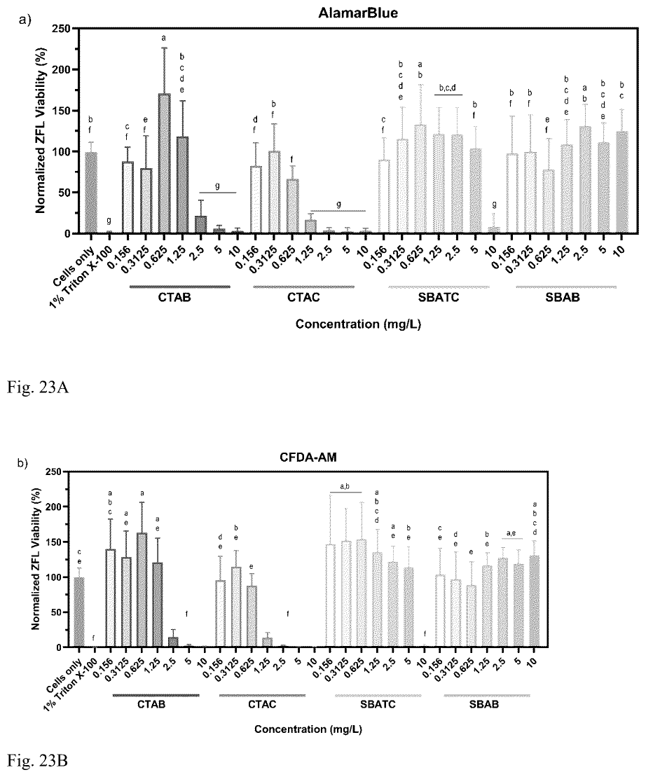

In addition to assessing the effect of surfactants in the human intestinal cell model, acute fish toxicity (AFT) tests were conducted to evaluate potential aquatic environmental hazards and risks. The ZFL cell line response to 24-hour exposure to CTAB, CTAC, SBATC, and SBAB was measured using two viability assays simultaneously; AB and CFDA-AM. As shown in FIG. 23A, the cellular metabolic activity of ZFL cells was significantly reduced compared to untreated controls following exposure to CTAB and CTAC. Notably, a broader range of CTAB concentrations decreased cell viability, with as low as 2.5 mg/L resulting in a ~21% reduction in normalized cell viability. Similarly, CTAB concentrations of 5 and 10 mg/L led to ~6% and ~3% normalized ZFL cell viability, respectively. Furthermore, the cationic surfactant CTAC caused a greater decrease in ZFL cell viability ranging from ~66% at 0.625 mg/L, ~17% at 1.25 mg/L, to ~3% at 10 mg/L. In contrast, the shea butter-derived cationic surfactant SBATC decreased normalized ZFL cell viability to ~9% only at the highest concentration of 10 mg/L. Exposure of ZFL cells to the zwitterionic SBAB surfactant did not result in a significant decrease in cell viability compared to untreated controls over the range of concentrations tested.

To further examine ZFL cell viability, CFDA-AM was used to measure intracellular esterase activity. As shown in FIG. 23B, CTAB and CTAC significantly decreased cell viability, with a ~14% normalized cell viability at 2.5 mg/L for CTAB and ~13% normalized cell viability at 1.25 mg/L for CTAC. Consistent with the cellular metabolic activity measurements, SBATC decreased viability to ~2% at 10 mg/L. In contrast, exposure of ZFL cells to SBAB did not negatively affect cell viability. Of note, higher concentrations of SBAB resulted in viability exceeding that of the untreated control group, indicating increased intracellular esterase activity.

The toxicity results in ZFL cells showed a decrease in cell viability upon exposure to the conventional PFAS remediation chemicals CTAC and CTAB, compared with the shea butter-derived surfactants SBATC and SBAB. SBATC exhibited toxicity only at the highest concentration tested (10 mg/L); however, at lower concentrations (0.156-5 mg/L), ZFL cell viability remained significantly higher than in cells treated with CTAC (0.625-10 mg/L) or CTAB (2.5-10 mg/L), indicating lower cytotoxicity compared to the CTAB and CTAC. Previous studies on the toxicity of cationic surfactants toward marine species have demonstrated the detrimental effects of both CTAC and CTAB, showing inhibition of oxygen activity in marine microalgae with a 50% reduction in photosynthetic response, and significant toxicity in marine species. See, Kaczerewska, O. et al., J. Environmental Behaviour and Ecotoxicity of Cationic Surfactants towards Marine Organisms. Journal of Hazardous Materials 2020, 392, 122299; Liu, N. et al., Mechanisms of Cetyltrimethyl Ammonium Chloride-Induced Toxicity to Photosystem II Oxygen Evolution Complex of Chlorella vulgaris F1068. Journal of Hazardous Materials 2020, 383, 121063. Shea butter-derived surfactants exhibited minimal toxicity in the aquatic ZFL cell line, making them suitable for PFAS remediation.

### Example XV

### Embodiments

Aspects of the present disclosure are directed to a method including (a) combining contaminated water including anionic PFAS molecules including a per- or polyfluorinated carbon chain of from C3 to C20 with one or more cationic molecules including (1) a carbon chain of C14 to C22 connected to (2) a head group having a cationic charge and having (3) a counter ion, and with the proviso that the one or more cationic molecules do not include CTAB or CTAC, and (b) creating bubbles within the contaminated water, wherein the one or more anionic molecules and the one or more cationic molecules bind together and orient at the gas-water interface of the bubbles, and wherein the bubbles rise to the surface of the contaminated water, and (c) removing bound anionic and cationic molecules at the surface of the contaminated water to create decontaminated water. According to one aspect, the PFAS molecules include PFAS molecules having a carbon chain of between 3 to 7 carbon atoms and PFAS molecules having a carbon chain of between 8 and 20 carbon atoms. According to one aspect, the head group having a cationic charge includes methyl ammonium, dimethyl ammonium, trimethyl ammonium, or betaine, and wherein the counter ion includes bromine or chlorine. According to one aspect, the head group having a cationic charge includes a zwitterionic group. According to one aspect, the head group having a cationic charge includes a zwitterionic group and the water is characterized by a pH of from about 3 to about 7. According to one aspect, the one or more anionic PFAS molecules include perfluorooctanoic acid (PFOA), perfluorooctanesulfonic acid (PFOS), perfluorohexanesulfonic acid (PFHxS), perfluorononanoic acid (PFNA), perfluorodecanoic acid (PFDA), perfluoroundecanoic acid (PFUnA), perfluorododecanoic acid (PFDoA), Perfluorobutanesulfonic acid potassium salt (PFBS), nanofluoro-1-butanesulfonic acid potassium salt (PFBS), or Perfluorobutanoic acid (PFBA). According to one aspect, the one or more cationic molecules are derived or synthesized from a natural material comprising one or more fatty acids, and wherein the natural material includes shea butter, shea butter-based material, canola oil, mango butter, kokum butter, cocoa butter, jojoba oil, avocado oil, almond oil, coconut butter, cupuacu butter, macadamia butter, or olive butter, or a mixture thereof. According to one aspect, the step (b) of creating bubbles within the contaminated water further includes creating a foam comprising the one or more anionic PFAS molecules at the surface of the contaminated water, and removing the foam from the contaminated water to thereby remove the one or more anionic PFAS molecules from the contaminated water. According to one aspect, the bubbles include ozone, air, nitrogen, oxygen, or carbon dioxide, or a combination thereof. According to one aspect, the contaminated water includes surface water, ground water, well water, rain water, environmental water, wastewater, desalinated water, glacial water, ice melt water, well water, soft water, or hard water, or a combination thereof. According to one aspect, the contaminated water includes about 0.01 ng/L to about 100,000 ng/L of the one or more anionic PFAS molecules. According to one aspect, the decontaminated water includes about 0.01 ng/L to about 70 ng/L of the one or more anionic PFAS molecules. According to one aspect, about 50% to about 99.9% of the one or more anionic PFAS molecules are removed from the decontaminated water. According to one aspect, the bound anionic PFAS molecules and cationic molecules at the surface of the contaminated water are removed by vacuum. According to one aspect, about 2% of the one or more anionic PFAS molecules remain in the decontaminated water. According to one aspect, about 1% of the one or more anionic PFAS molecules remain in the decontaminated water. According to one aspect, the one or more cationic molecules are present in the contaminated water in an amount of about 0.01 wt % to about 10 wt % based on the total weight of the one or more anionic PFAS molecules in the contaminated water. According to one aspect, the contaminated water is at a temperature of about 10 °C to about 100 °C. According to one aspect, the one or more cationic molecules are present in the contaminated water for about 1 minute to about 24 hours. According to one aspect, the one or more anionic PFAS molecules are present in the contaminated water in a concentration of about 0.01 ppb to about 1000 ppb. According to one aspect, the one or more anionic PFAS molecules are present in the decontaminated water in a concentration of less than about 70 ppt. According to one aspect, the method further includes repeating steps (a), (b) and (c) with the decontaminated water. According to one aspect, the method further includes separating the one or more cationic molecules from the decontaminated water. According to one aspect, the step (b) of creating bubbles within the contaminated water further includes creating a foam including the one or more anionic PFAS molecules at the surface of the contaminated water, and removing the foam from the contaminated water by skimming the foam, by decanting the foam, by filtering the foam or by removing the foam under reduced pressure. According to one aspect, the step (b) of creating bubbles within the contaminated water further includes creating a foam including the one or more anionic PFAS molecules at the surface of the contaminated water by agitating, shaking, or stirring the contaminated water, or bubbling gas through the contaminated water, and removing the foam from the contaminated water to thereby remove the one or more anionic molecules from the contaminated water. According to one aspect, the method further includes separating cationic molecules from the removed bound anionic PFAS molecules and cationic molecules, and reusing the cationic molecules in step (a). According to one aspect, the one or more cationic molecules are mixed with the contaminated water, and a foam is produced from the contaminated water.

The present disclosure provides a mixture including contaminated water including anionic PFAS molecules including a per- or polyfluorinated carbon chain of from C3 to C20, and one or more cationic molecules including (1) a carbon chain of C14 to C22 connected to (2) a head group having a cationic charge and having (3) a counter ion, wherein the one or more cationic molecules are derived or synthesized from a natural material comprising one or more fatty acids, and with the proviso that the one or more cationic molecules do not comprise CTAB or CTAC.

The present disclosure provides a system for purifying PFAS contaminated water, the system including one or more cationic molecules including (1) a carbon chain of C14 to C22 connected to (2) a head group having a cationic charge and having (3) a counter ion, wherein the one or more cationic molecules are derived or synthesized from a natural material comprising one or more fatty acids, and with the proviso that the one or more cationic molecules do not comprise CTAB or CTAC; a mixing vessel for mixing the one or more cationic molecules with the PFAS contaminated water to generate a mixture; an agitator for agitating the mixture in the mixing vessel to generate a foam containing the PFAS; a separator for separating the foam from the purified water after purifying the PFAS contaminated water, wherein the separator includes at least one of a skimmer, a decanter, a filter, or a reduced pressure system; a disposal unit for disposing of the foam; and a recycling unit for recycling the foam obtain the one or more cationic molecules.

1. A method comprising
(a) combining contaminated water including anionic PFAS molecules including a per- or polyfluorinated carbon chain of from C3 to C20 with one or more cationic molecules including (1) a carbon chain of C14 to C22 connected to (2) a head group having a cationic charge and having (3) a counter ion, and
with the proviso that the one or more cationic molecules do not comprise CTAB or CTAC, and
(b) creating bubbles within the contaminated water, wherein the one or more anionic molecules and the one or more cationic molecules bind together and orient at the gas-water interface of the bubbles, and wherein the bubbles rise to the surface of the contaminated water, and
(c) removing bound anionic and cationic molecules at the surface of the contaminated water to create decontaminated water.

2. The method of claim 1 wherein the PFAS molecules comprise PFAS molecules having a carbon chain of between 3 to 7 carbon atoms and PFAS molecules having a carbon chain of between 8 and 20 carbon atoms.

3. The method of claim 1 wherein the head group having a cationic charge comprises methyl ammonium, dimethyl ammonium, trimethyl ammonium, or betaine, and wherein the counter ion comprises bromine or chlorine.

4. The method of claim 1 wherein the head group having a cationic charge comprises a zwitterionic group.

5. The method of claim 1 wherein the head group having a cationic charge comprises a zwitterionic group and the water is characterized by a pH of from about 3 to about 7.

6. The method of claim 1 wherein the one or more anionic PFAS molecules comprise perfluorooctanoic acid (PFOA), perfluorooctanesulfonic acid (PFOS), perfluorohexanesulfonic acid (PFHxS), perfluorononanoic acid (PFNA), perfluorodecanoic acid (PFDA), perfluoroundecanoic acid (PFUnA), perfluorododecanoic acid (PFDoA), Perfluorobutanesulfonic acid potassium salt (PFBS), nanofluoro-1-butanesulfonic acid potassium salt (PFBS), or Perfluorobutanoic acid (PFBA).

7. The method of claim 1 wherein the one or more cationic molecules are derived or synthesized from a natural material comprising one or more fatty acids, and wherein the natural material comprises shea butter, shea butter-based material, canola oil, mango butter, kokum butter, cocoa butter, jojoba oil, avocado oil, almond oil, coconut butter, cupuacu butter, macadamia butter, or olive butter, or a mixture thereof.

8. The method of claim 1 wherein the step (b) of creating bubbles within the contaminated water further comprises creating a foam comprising the one or more anionic PFAS molecules at the surface of the contaminated water, and removing the foam from the contaminated water to thereby remove the one or more anionic PFAS molecules from the contaminated water.

9. The method of claim 1 wherein the bubbles comprise ozone, air, nitrogen, oxygen, or carbon dioxide, or a combination thereof.

10. The method of claim 1 wherein the contaminated water comprises surface water, ground water, well water, rain water, environmental water, wastewater, desalinated water, glacial water, ice melt water, well water, soft water, or hard water, or a combination thereof.

11. The method of claim 1 wherein the contaminated water comprises about 0.01 ng/L to about 100,000 ng/L of the one or more anionic PFAS molecules.

12. The method of claim 1 wherein the decontaminated water comprises about 0.01 ng/L to about 70 ng/L of the one or more anionic PFAS molecules.

13. The method of claim 1 wherein about 50% to about 99.9% of the one or more anionic PFAS molecules are removed from the decontaminated water.

14. The method of claim 1 wherein the bound anionic PFAS molecules and cationic molecules at the surface of the contaminated water are removed by vacuum.

15. The method of claim 1 wherein about 2% of the one or more anionic PFAS molecules remain in the decontaminated water.

16. The method of claim 1 wherein about 1% of the one or more anionic PFAS molecules remain in the decontaminated water.

17. The method of claim 1 wherein the one or more cationic molecules are present in the contaminated water in an amount of about 0.01 wt % to about 10 wt % based on the total weight of the one or more anionic PFAS molecules in the contaminated water.

18. The method of claim 1 wherein the contaminated water is at a temperature of about 10 °C to about 100 °C.

19. The method of claim 1 wherein the one or more cationic molecules are present in the contaminated water for about 1 minute to about 24 hours.

20. The method of claim 1 wherein the one or more anionic PFAS molecules are present in the contaminated water in a concentration of about 0.01 ppb to about 1000 ppb.

21. The method of claim 1 wherein the one or more anionic PFAS molecules are present in the decontaminated water in a concentration of less than about 70 ppt.

22. The method of claim 1 further comprising repeating steps (a), (b) and (c) with the decontaminated water.

23. The method of claim 1 further comprising separating the one or more cationic molecules from the decontaminated water.

24. The method of claim 1 wherein the step (b) of creating bubbles within the contaminated water further comprises creating a foam comprising the one or more anionic PFAS molecules at the surface of the contaminated water, and removing the foam from the contaminated water by skimming the foam, by decanting the foam, by filtering the foam or by removing the foam under reduced pressure.

25. The method of claim 1 wherein the step (b) of creating bubbles within the contaminated water further comprises creating a foam comprising the one or more anionic PFAS molecules at the surface of the contaminated water by agitating, shaking, or stirring the contaminated water, or bubbling gas through the contaminated water, and removing the foam from the contaminated water to thereby remove the one or more anionic molecules from the contaminated water.

26. The method of claim 1 further comprising separating cationic molecules from the removed bound anionic PFAS molecules and cationic molecules, and reusing the cationic molecules in step (a).

27. The method of claim 1 wherein the one or more cationic molecules are mixed with the contaminated water, and a foam is produced from the contaminated water.

28. A mixture comprising
contaminated water including anionic PFAS molecules including a per- or polyfluorinated carbon chain of from C3 to C20, and
one or more cationic molecules including (1) a carbon chain of C14 to C22 connected to (2) a head group having a cationic charge and having (3) a counter ion,
wherein the one or more cationic molecules are derived from or synthesized from a natural material comprising one or more fatty acids, and
with the proviso that the one or more cationic molecules do not comprise CTAB or CTAC.

29. A system for purifying PFAS contaminated water, the system comprising:
one or more cationic molecules including (1) a carbon chain of C14 to C22 connected to (2) a head group having a cationic charge and having (3) a counter ion,
wherein the one or more cationic molecules are derived from or synthesized from a natural material comprising one or more fatty acids, and
with the proviso that the one or more cationic molecules do not comprise CTAB or CTAC;
a mixing vessel for mixing the one or more cationic molecules with the PFAS contaminated water to generate a mixture;
an agitator for agitating the mixture in the mixing vessel to generate a foam containing the PFAS;
a separator for separating the foam from the purified water after purifying the PFAS contaminated water, wherein the separator comprises at least one of a skimmer, a decanter, a filter, or a reduced pressure system;
a disposal unit for disposing of the foam; and
a recycling unit for recycling the foam obtain the one or more cationic molecules.
